(19) United States
(12) Patent Application Publication
(10) Pub. No.: US 2024/0306222 A1
(43) Pub. Date: Sep. 12, 2024

(54) NODE DEVICE, AMF, AND TERMINAL DEVICE

(71) Applicant: GUANGDONG OPPO MOBILE TELECOMMUNICATIONS CORP., LTD., Dongguan (CN)

(72) Inventors: Fei LU, Dongguan (CN); Haorui YANG, Dongguan (CN)

(21) Appl. No.: 18/663,917

(22) Filed: May 14, 2024

Related U.S. Application Data
(63) Continuation of application No. PCT/CN2021/131699, filed on Nov. 19, 2021.

(51) Int. Cl. H04W 76/10; H04W 60/04; H04W 92/18

(52) U.S. Cl. CPC H04W 76/10; H04W 60/04; H04W 92/18

(57) ABSTRACT

Provided is a node device. The node device is a device for connecting an access and mobility management function (AMF) to a terminal device and the node device includes a transceiver. The transceiver is configured to receive a plurality of temporary identifiers allocated in bulk by the AMF; and the transceiver is configured to separately allocate one of the plurality of temporary identifiers to the terminal device.

### CROSS-REFERENCE TO RELATED APPLICATION

This application is a continuation application of International Application No. PCT/CN2021/131699, filed on Nov. 19, 2021, the entire contents of which are incorporated herein by reference.

### TECHNICAL FIELD

Embodiments of the present disclosure relate to the technical field of communications, and in particular, relate to an identifier allocation method, an identifier reporting method, an apparatus, a device and a storage medium.

### BACKGROUND

In a communications system, an access and mobility management function (AMF) enables terminal devices to access a core network, and performs mobility management for the terminal devices. For example, the AMF allocates temporary identifiers to the terminal devices.

### SUMMARY

Embodiments of the present disclosure provide an identifier allocation method, an identifier reporting method, an apparatus, a device and a storage medium. The technical solutions are as below.

According to some embodiments of the embodiments of the present disclosure, an identifier allocation method is provided. The method is applicable to a node device. The node device is a device for connecting an AMF to a terminal device.

The method includes: receiving a plurality of temporary identifiers allocated in bulk by the AMF; and separately allocating one of the plurality of temporary identifiers to the terminal device.

According to some embodiments of the embodiments of the present disclosure, an identifier allocation method is provided. The method is applicable to an AMF.

The method includes: transmitting a plurality of temporary identifiers allocated in bulk by the AMF to a node device, such that the node device separately allocates one of the plurality of temporary identifiers to a terminal device, wherein the node device is a device for connecting the AMF to the terminal device.

According to some embodiments of embodiments of the present disclosure, an identifier allocation method is provided. The method is applicable to a terminal device.

The method includes: receiving a temporary identifier separately allocated by a node device, wherein the node device is a device for connecting the AMF to the terminal device, and the temporary identifier is one of a plurality of temporary identifiers centrally allocated by the AMF to the node device.

According to some embodiments of the embodiments of the present disclosure, an identifier reporting method is provided. The method is applicable to a node device which is a device for connecting an AMF to a terminal device.

The method includes: transmitting a report message to the AMF, wherein the report message carries a plurality of temporary identifiers, and each of the plurality of temporary identifiers has been configured for a corresponding terminal device.

According to some embodiments of the embodiments of the present disclosure, an identifier reporting method is provided. The method is applicable to an AMF.

The method includes: receiving a report message from a node device, wherein the report message carries a plurality of temporary identifiers, each of the plurality of temporary identifiers has been configured for a corresponding terminal device, and the node device is a device for connecting the AMF to the terminal device.

According to some embodiments of the embodiments of the present disclosure, an identifier reporting method is provided. The method is applicable to a terminal device.

The method includes: enabling a node device to acknowledge a temporary identifier that has been configured for the terminal device by a negotiation process between the terminal device and the node device, wherein the node device is a device for connecting an AMF to the terminal device.

According to some embodiments of the embodiments of the present disclosure, an identifier allocation apparatus is provided. The identifier allocation apparatus is an apparatus for connecting an AMF to a terminal device.

The apparatus includes an identifier receiving module and an identifier allocating module; wherein the identifier receiving module is configured to receive a plurality of temporary identifiers allocated in bulk by the AMF; and the identifier allocating module is configured to separately allocate one of the plurality of temporary identifiers to the terminal device.

According to some embodiments of the embodiments of the present disclosure, an identifier allocation apparatus is provided.

The apparatus includes an identifier allocating module; wherein the identifier allocating module is configured to transmit a plurality of temporary identifiers allocated in bulk by the AMF to a node device, to cause the node device to separately allocate one of the plurality of temporary identifiers to a terminal device, wherein the node device is a device for connecting the apparatus to the terminal device.

According to some embodiments of the embodiments of the present disclosure, an identifier allocation apparatus is provided.

The apparatus includes an identifier receiving module; wherein the identifier receiving module is configured to receive a temporary identifier separately allocated by a node device, wherein the node device is a device for connecting an AMF to the apparatus, and the temporary identifier is one of a plurality of temporary identifiers allocated in bulk by the AMF to the node device.

According to some embodiments of the embodiments of the present disclosure, an identifier reporting apparatus is provided. The apparatus is an apparatus for connecting an AMF to a terminal device.

The apparatus includes a message reporting module; wherein the message reporting module is configured to transmit a report message to the AMF, wherein the report message carries a plurality of temporary identifiers, and each of the plurality of temporary identifiers temporary identifier has been configured for a corresponding terminal device.

According to some embodiments of the embodiments of the present disclosure, an identifier reporting apparatus is provided.

The apparatus includes a message receiving module; wherein the message receiving module is configured to receive a report message from a node device, wherein the report message carries a plurality of temporary identifiers, each of the plurality of temporary identifiers has been configured for a corresponding terminal device, and the node device is a device for connecting the apparatus to the terminal device.

According to some embodiments of the embodiments of the present disclosure, an identifier reporting apparatus is provided.

The apparatus includes a negotiating module; wherein the negotiating module is configured to enable a node device to acknowledge a temporary identifier corresponding to the apparatus by a negotiation process between the apparatus and the node device, wherein the node device is a device for connecting an AMF to the apparatus.

According to some embodiments of the embodiments of the present disclosure, a node device is provided. The node device is a device for connecting an AMF to a terminal device.

The node device includes a transceiver; wherein the transceiver is configured to receive a plurality of temporary identifiers allocated in bulk by the AMF; and the transceiver is configured to separately allocate one of the plurality of temporary identifiers to the terminal device.

According to some embodiments of the embodiments of the present disclosure, an AMF is provided.

The AMF includes a transceiver; wherein the transceiver is configured to transmit a plurality of temporary identifiers allocated in bulk by the AMF to a node device, such that the node device separately allocates one of the plurality of temporary identifiers to a terminal device, wherein the node device is a device for connecting the AMF to the terminal device.

According to some embodiments of the embodiments of the present disclosure, a terminal device is provided.

The terminal device includes a transceiver; wherein the transceiver is configured to receive a temporary identifier separately allocated by a node device, wherein the node device is a device for connecting an AMF to the terminal device, and the temporary identifier is one of a plurality of temporary identifiers allocated in bulk by the AMF to the node device.

According to some embodiments of the embodiments of the present disclosure, a node device is provided. The node device is a device for connecting an AMF to a terminal device.

The node device includes a transceiver; wherein the transceiver is configured to receive a plurality of temporary identifiers allocated in bulk by the AMF; and the transceiver is configured to separately allocate one of the plurality of temporary identifiers to the terminal device.

According to some embodiments of the embodiments of the present disclosure, an AMF is provided.

The AMF includes a transceiver; wherein the transceiver is configured to receive a report message from a node device, wherein the report message carries a plurality of temporary identifiers, each of the plurality of temporary identifiers has been configured for a corresponding terminal device, and the node device is a device for connecting the AMF to the terminal device.

According to some embodiments of the embodiments of the present disclosure, a terminal device is provided.

The terminal device includes a transceiver; wherein the transceiver is configured to enable a node device to acknowledge a temporary identifier that has been configured for the terminal device by a negotiation process between the terminal device and the node device, wherein the node device is a device for connecting an AMF to the terminal device.

According to some embodiments of the embodiments of the present disclosure, a non-transitory computer-readable storage medium is provided. The storage medium stores a computer program. The computer program, when run a processor, causes the processor to perform the identifier allocation method or the identifier reporting method as described above.

According to some embodiments of embodiments of the present disclosure, a chip is provided. The chip includes a programmable logic circuit and/or program instructions. wherein the chip, when running, is configured to perform the identifier allocation method or the identifier reporting method as described above.

According to some embodiments of embodiments of the present disclosure, a computer program product or a computer program is provided. The computer program product or the computer program includes computer instructions stored in a computer-readable storage medium, wherein the computer instructions, when read from the computer-readable storage medium and executed by a processor, cause the processor to perform the identifier allocation method or the identifier reporting method as described above.

### BRIEF DESCRIPTION OF DRAWINGS

For clearer descriptions of the technical solutions in the embodiments of the present disclosure, the following briefly introduces the accompanying drawings required for describing the embodiments. Apparently, the accompanying drawings in the following description show merely some embodiments of the present disclosure, and a person of ordinary skill in the art may still derive other drawings from these accompanying drawings without creative efforts.

FIG. 1 is a schematic diagram of a zero-power communication technology according to some exemplary embodiments of the present disclosure;

FIG. 2 is a schematic diagram of system architecture of a 5G network according to some exemplary embodiments of the present disclosure;

FIG. 3 is a schematic diagram of a registration process according to some exemplary embodiments of the present disclosure;

FIG. 4 is a schematic diagram of a communication system according to some exemplary embodiments of the present disclosure;

FIG. 5 is a flowchart of an identifier allocation method according to some exemplary embodiments of the present disclosure;

FIG. 6 is a flowchart of another identifier allocation method according to some exemplary embodiments of the present disclosure;

FIG. 7 is a flowchart of an identifier reporting method according to some exemplary embodiments of the present disclosure;

FIG. 8 is a flowchart of an identifier reporting method according to some exemplary embodiments of the present disclosure;

FIG. 9 is a flowchart of an identifier reporting method according to some exemplary embodiments of the present disclosure;

FIG. 10 is a flowchart of an identifier allocating and reporting method according to some exemplary embodiments of the present disclosure;

FIG. 11 is a flowchart of an identifier allocating and reporting method according to some exemplary embodiments of the present disclosure;

FIG. 12 is a flowchart of an identifier allocating and reporting method according to some exemplary embodiments of the present disclosure;

FIG. 13 is a flowchart of an identifier allocating and reporting method according to some exemplary embodiments of the present disclosure;

FIG. 14 is a flowchart of an identifier allocating and reporting method according to some exemplary embodiments of the present disclosure;

FIG. 15 is a flowchart of an identifier allocating and reporting method according to some exemplary embodiments of the present disclosure;

FIG. 16 is a block diagram of an identifier allocation apparatus according to some exemplary embodiments of the present disclosure;

FIG. 17 is a block diagram of an identifier allocation apparatus according to some exemplary embodiments of the present disclosure;

FIG. 18 is a block diagram of an identifier allocation apparatus according to some exemplary embodiments of the present disclosure;

FIG. 19 is a block diagram of an identifier reporting apparatus according to some exemplary embodiments of the present disclosure;

FIG. 20 is a block diagram of an identifier reporting apparatus according to some exemplary embodiments of the present disclosure;

FIG. 21 is a block diagram of an identifier reporting apparatus according to some exemplary embodiments of the present disclosure; and

FIG. 22 is a structural schematic diagram of a communication device according to some exemplary embodiments of the present disclosure.

### DETAILED DESCRIPTION

For clearer descriptions of the objectives, technical solutions and advantages of the present disclosure, the embodiments of the present disclosure are described in detail hereinafter with reference to the accompanying drawings.

Network architecture and service scenarios described in the embodiments of the present disclosure are intended to describe the technical solutions of the embodiments of the present disclosure more clearly, and do not constitute a limitation to the technical solutions according to the embodiments of the present disclosure. A person of ordinary skill in the art may acknowledge that, with evolution of the network architecture and the emergence of new service scenarios, the technical solutions according to the embodiments of the present disclosure are equally applicable to similar technical problems.

Before the technical solutions of the present disclosure are introduced, some technical knowledge involved in the present disclosure is firstly introduced and explained.

### Zero-Power-Consumption Device

A zero-power-consumption communication network is a short-range and low-speed wireless communication technology. A device in the zero-power-consumption communication network is a zero-power-consumption device. The zero-power devices mainly combine a radio frequency (RF) energy harvesting technology, a backscatter technology and a low-power-consumption computing technology to achieve the advantage that a device node does not carry a power supply.

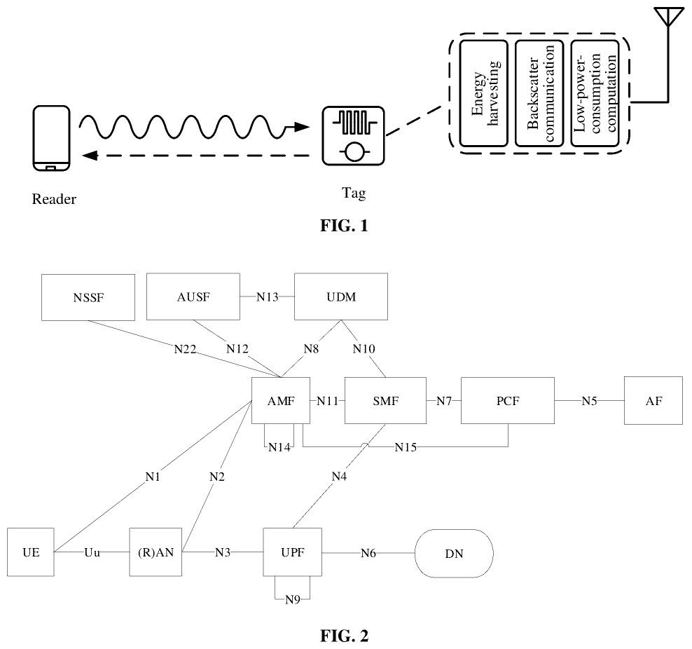

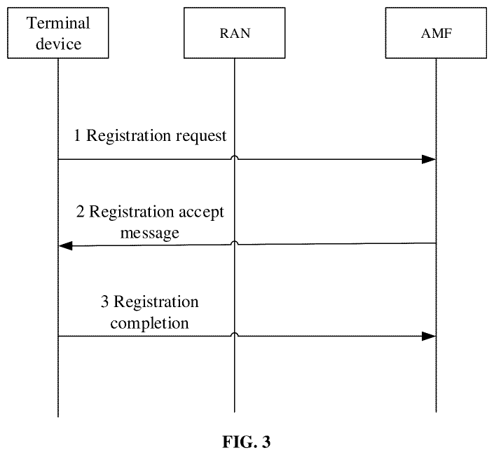

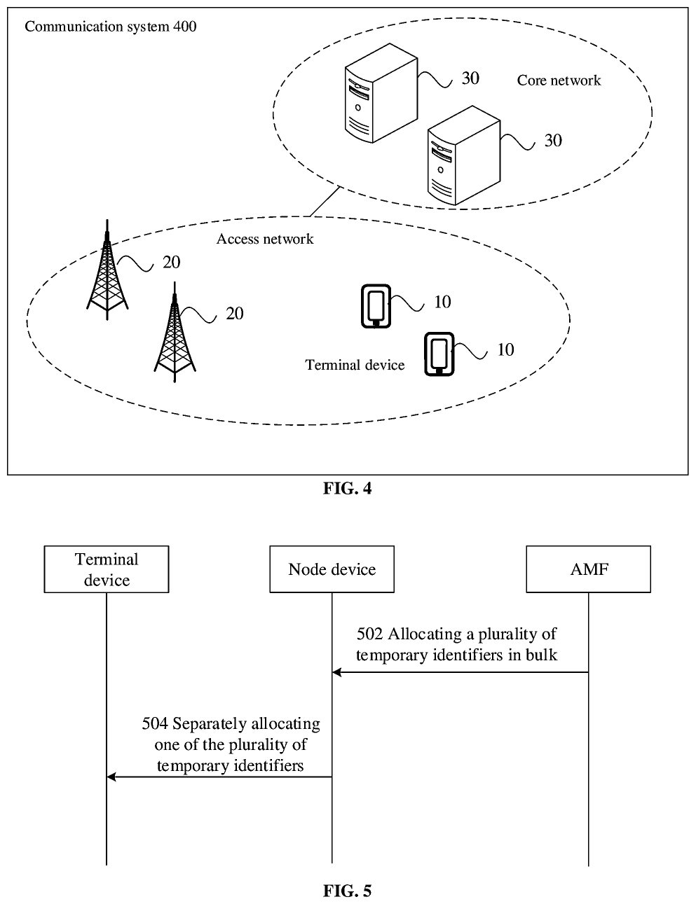

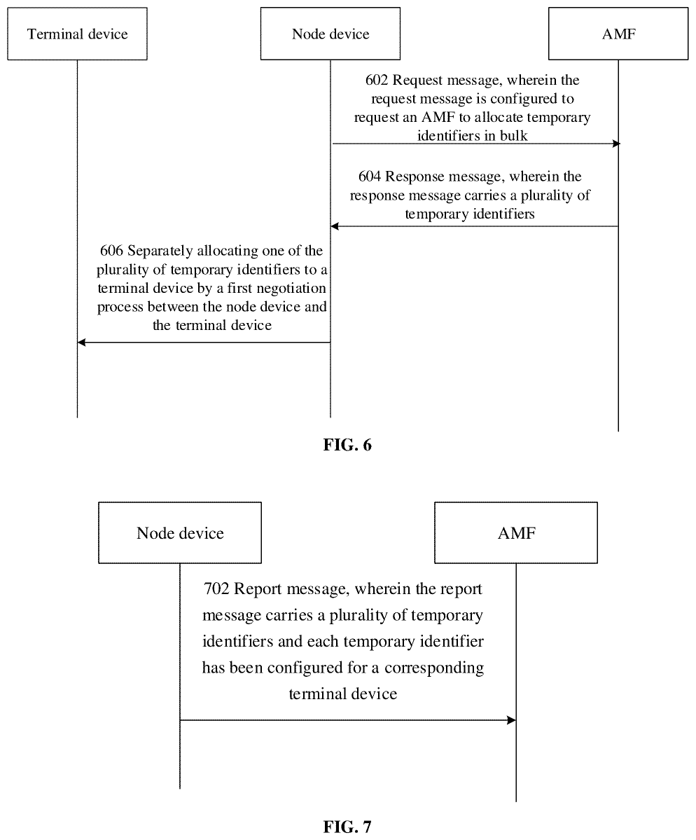

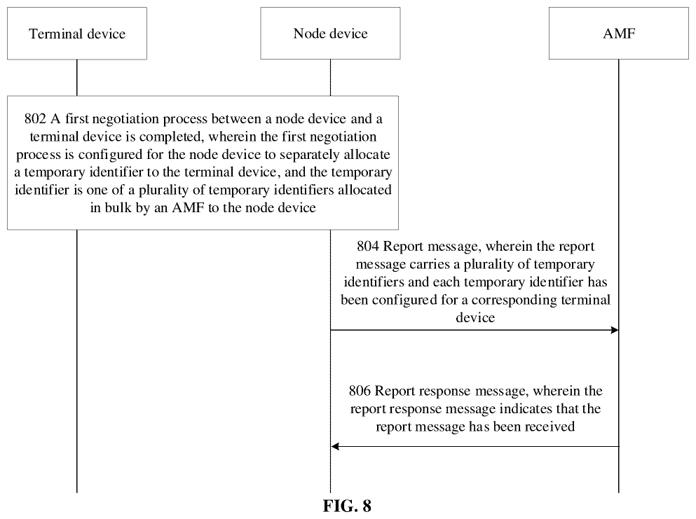

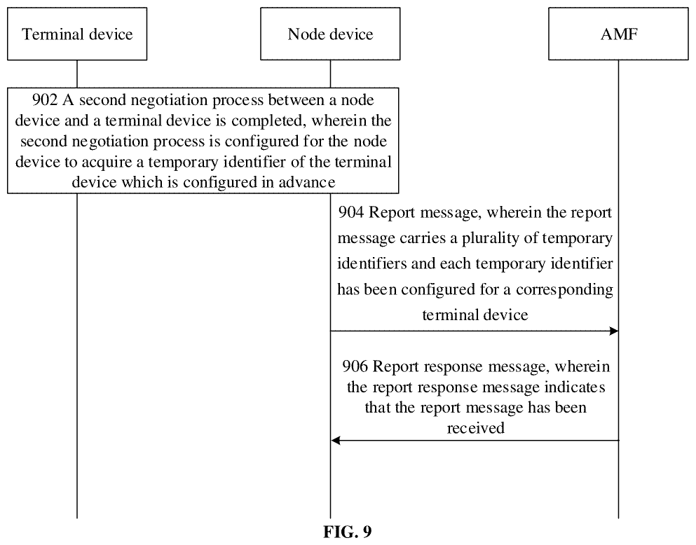

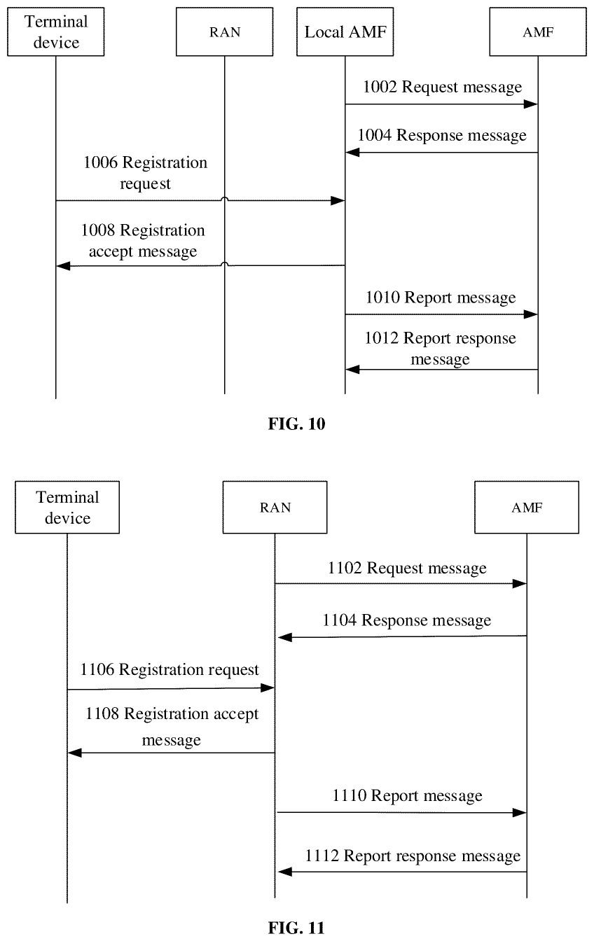

As shown in FIG. 1, the core of RF energy harvesting is to convert RF energy to direct currents. The energy may be stored in batteries or capacitors, or it may be collected and then used directly to drive logic circuits, digital chips, or sensors to complete modulation and emission of backscattered signals, collection and processing of sensing information and other functions and applications.

The zero-power-consumption device may be referred to as a zero-power-consumption terminal, a passive terminal, a passive device, etc. In the embodiments of the present disclosure, the description is given by taking that the zero-power-consumption device is the passive terminal as an example.

### System Architecture of 5G Network

Referring to FIG. 2, the system architecture of a 5G network includes a user equipment (UE), a (radio) access network ((R)AN), a user plane function (UPF), a data network (DN) and a control plane function.

The control plane function includes an AMF, a session management function (SMF), a policy control function (PCF), unified data management (UDM), an application function (AF), a network slice selection function (NSSF) and an authentication server function (AUSF).

The AMF refers to a mobility management function element in a core network, and the SMF refers to a session management function element in the core network. In addition to mobility management for the UE, the AMF also forwards messages related to session management between the UE and the SMF. The PCF refers to a policy management function element in the core network, and formulates policies related to mobility management, session management, charging and the like for the UE. The UPF refers to a user plane-specific function element in the core network, and transmits data with an external data network over an N6 interface and transmits data with a RAN over an N3 interface.

In the related arts, the AMF allocates a temporary identifier to each of the terminal devices in a registration process of the terminal device. In traditional system architecture of the 5G network, a temporary identifier of a terminal device is allocated by the AMF. However, the actual AMF is often concentrated, which results in the transmission delay or distance between the terminal device and the AMF being not optimized. A registration process of the terminal device is as shown in FIG. 3. The terminal device transmits a registration request to the AMF, and registration accept message returned by the AMF carries the temporary identifier allocated to the terminal device. It may be understood that these registration processes are managed based on each terminal device. The management here includes the allocation of a temporary identifier of each terminal device and the maintenance of a connection state or a mobility management state of each terminal device.

In the embodiments of the present disclosure, in view of the above problems, in a scenario of allocating the temporary identifiers to the terminal devices, the node device is introduced, the AMF allocates in bulk a plurality of temporary identifiers to the node device, and then the node device separately allocates the temporary identifier to the terminal device. In this way, it is convenient for the node device to uniformly manage the temporary identifiers of a plurality of terminal devices. In addition, Compared with the technical solution in which temporary identifiers are allocated to the terminal devices in a one-to-one correspondence manner by the AMF disposed more distal to the terminal device, in the technical solution according to the embodiments of the present disclosure, the node device may be disposed at a location closer to the terminal device, such that the efficiency of the temporary identifier allocation is improved and the power consumption of the terminal devices is reduced.

In some exemplary embodiments, the terminal device is a passive terminal, i.e., a zero-power-consumption terminal. In a logistics scenario, such as a large number of passive terminals on a transport vehicle, based on the technical solutions according to the embodiments of the present disclosure, a node device disposed near the transport vehicle (for example, the node device is a local AMF in a moving state on the transport vehicle) allocates in bulk temporary identifiers for these passive terminals, thereby facilitating unified and centralized management of these passive terminals.

The technical solutions according to the present disclosure are introduced and explained hereinafter through several embodiments.

Referring to FIG. 4, a schematic diagram of a communication system 400 according to some embodiments of the present disclosure is shown. The communication system 400 may include a terminal device 10, an access network device 20, and a core network device 30.

The terminal device 10 may be referred to as a UE, an access terminal, a subscriber unit, a subscriber station, a mobile station (MS), a remote station, a remote terminal, a mobile device, a wireless communication device, a user agent, or a user apparatus. In some embodiments, the terminal device 10 may also be referred to as a cellular phone, a cordless phone, a session initiation protocol (SIP) phone, a wireless local loop (WLL) station, a personal digital assistant (PDA), a handheld device having a wireless communication functions, a computing device or other processing devices connected to a wireless modem, a vehicle-mounted device, a wearable device, a terminal device in the 5th generation system (5GS) or a terminal device in a future evolved public land mobile network (PLMN), which is not limited in the embodiments of the present disclosure. For convenience of description, the devices described above are collectively referred to as the terminal device. Generally, a plurality of terminal devices 10 are present, and one or more terminal devices 10 may be distributed in a cell managed by each access network device 20.

The access network device 20 is a device deployed in an access network for providing a wireless communication function for the terminal devices 10. The access network device 20 may include various forms of macro base stations, micro base stations, relay stations, access points, and the like. In a system adopting different wireless access technologies, a device with the function of an access network device may have different names. For example, in the 5G NR system, the device is referred to as gNodeB or gNB. With the evolution of communications technologies, the name “access network device” may vary. For convenience of description, in the embodiments of the present disclosure, the above devices that provide the wireless communication function for the terminal device 10 are collectively referred to as the access network device. In some embodiments, a communication relationship may be established between the terminal device 10 and the core network device 30 over the access network device 20. In some exemplary embodiments, in a long-term evolution (LTE) system, the access network device 20 may be an evolved universal terrestrial radio access network (EUTRAN) or one or more eNodeBs in the EUTRAN; and in a 5G NR system, the access network device 20 may be a RAN or one or more gNBs in the RAN.

The core network device 30 is a device deployed in the core network and the functions of the core network device 30 are mainly to provide a user connection, user management and service bearing, and to provide an interface to an external network as a bearer network. For example, the core network device in the 5G NR system may include devices such as an AMF entity, a user plane function (UPF) entity, and an SMF entity.

In one example, the access network device 20 communicates with the core network device 30 using the air interface technology, such as an NG interface in the 5G NR system. The access network device 20 communicates with the terminal device 10 using the air interface technology, such as a Uu interface.

In some embodiments, the communication system 400 further includes a relay terminal which is also referred to as a relay UE. The relay terminal is a terminal device that has a capability to connect to an external data network over a 5G network and also has a proximity-based service (ProSe) capability. The ProSe supports communication between devices with physical addresses proximal to one another. The terminal device 10 may directly communicate with the relay terminal over a PC5 interface.

In some embodiments, the communication system 400 further includes a local AMF. The local AMF is a network element device which is deployed near the terminal device 10 and configured to provide services for the terminal device 10. The local AMF is capable of providing all or part of services of a conventional AMF.

In addition, in the embodiments of the present disclosure, the terms “network” and “system” are often used interchangeably, but those skilled in the art may understand their meanings. The technical solutions described in the embodiments of the present disclosure may be applicable to the LTE system, the 5G system, and may also be applicable to a subsequent evolution system of a 5G NR system or other communication system, which is not limited in the embodiments of the present disclosure.

Referring to FIG. 5, a flowchart of an identifier allocation method according to some embodiments of the present disclosure is shown. The method may include the following steps.

In step 502, an AMF transmits a plurality of temporary identifiers allocated in bulk by the AMF to a node device.

Correspondingly, the node device receives the plurality of temporary identifiers allocated in bulk by the AMF.

The node device is a device for connecting the AMF and a terminal device. In some exemplary embodiments, the node device is disposed closer to the terminal device than the AMF. In the embodiments of the present disclosure, the node device includes one of a local AMF, a RAN, or a relay terminal.

The temporary identifier is a clear identifier provided to a communication device (such as the terminal device) in the communication system, and is used to establish a temporary identity of the communication device. In a case that the temporary identifier is used to identify the identity of the communication device, a permanent identity of the communication device will not be revealed. In some exemplary embodiments, the temporary identifier is a globally unique temporary identifier (GUTI), and the embodiments of the present disclosure do not limit the specific type of the temporary identifier.

In the embodiments of the present disclosure, the AMF transmits the plurality of temporary identifiers allocated in bulk to the node device, that is, the AMF transmits the plurality of different temporary identifiers to the node device. It may be understood that the AMF may allocate the plurality of different temporary identifiers to the node device at a time over one signaling transmission, or may allocate the plurality of different temporary identifiers to the node device in a period of time over multiple signaling transmissions.

The node device receives the plurality of temporary identifiers allocated in bulk by the AMF.

In step 504, the node device separately allocates one of the plurality of temporary identifiers to the terminal device.

Correspondingly, the terminal device receives the temporary identifier separately allocated by the node device. Upon receiving the temporary identifier allocated separately by the node device, the temporary identifier being configured for the terminal device can be acknowledged.

Upon receiving the plurality of temporary identifiers allocated in bulk by the AMF, the node device needs to allocate these temporary identifiers to the terminal devices. Specifically, the node device allocates one temporary identifier to one terminal device every time, and the terminal devices are in one-to-one correspondence with the temporary identifiers.

In some exemplary embodiments, the node device receives a temporary identifier a, a temporary identifier b, a temporary identifier c and a temporary identifier d allocated in bulk by the AMF. The node device transmits the temporary identifier a to a terminal device A, the temporary identifier b to a terminal device B, the temporary identifier c to a terminal device C, and the temporary identifier d to a terminal device D.

It may be understood that since the node device is responsible for receiving the plurality of temporary identifiers allocated in bulk by the AMF and then separately allocating the temporary identifier to the terminal device, the node device may be considered as a secondary node between the AMF and the terminal device.

In some embodiments, the terminal device is a passive terminal. That is, the identifier allocation method according to the embodiments of the present disclosure is an identifier allocation method for the passive terminal.

In summary, in the technical solutions according to the embodiments of the present disclosure, in a scenario of allocating the temporary identifiers to the terminal devices, the node device is introduced, the AMF allocates in bulk a plurality of temporary identifiers to the node device and then the node device separately allocates the temporary identifier to the terminal device. In this way, it is convenient for the node device to uniformly manage the temporary identifiers of a plurality of terminal devices. Compared with the technical solution in which temporary identifiers are allocated to the terminal devices in a one-to-one correspondence manner by the AMF disposed more distal to the terminal device, in the technical solution according to the embodiments of the present disclosure, the node device may be disposed at a location closer to the terminal device, such that the efficiency of the temporary identifier allocation is improved and the power consumption of the terminal devices is reduced.

In some exemplary embodiments, the AMF transmits the plurality of temporary identifiers to the node device upon the request of the node device; and the node device allocates the temporary identifier to the terminal device by a first negotiation process between the node device and the terminal device.

Referring to FIG. 6, a flowchart of an identifier allocation method according to some embodiments of the present disclosure is shown. The method may include the following steps.

In step 602, a node device transmits a request message to an AMF, wherein the request message is configured to request the AMF to allocate temporary identifiers in bulk.

Correspondingly, the AMF receives the request message from the node device.

In some exemplary embodiments, the request message is a bulk ID allocation request message.

In step 604, the AMF transmits a response message to the node device, wherein the response message carries a plurality of temporary identifiers.

Correspondingly, the node device receives the response message from the AMF.

Upon receiving the request message from the node device, the AMF transmits the response message carrying the plurality of temporary identifiers to the node device in a case of accepting the request from the node device.

In some exemplary embodiments, the response message is a bulk ID allocation response message.

In some embodiments, before step 604, the AMF determines the number of temporary identifiers to be transmitted to the node device by performing the following steps: the AMF determines the number of temporary identifiers in the response message based on the identifier request number carried in the request message, wherein the identifier request number is the number of temporary identifiers requested by the node device; or the AMF determines the number of temporary identifiers in the response message based on identity identification information of the node device.

That is, the number of temporary identifiers in the response message is determined by the AMF based on the identifier request number carried in the request message, wherein the identifier request number is the number of temporary identifiers requested by the node device; or the number of temporary identifiers in the response message is determined by the AMF based on the identity identification information of the node device.

In some exemplary embodiments, the request message from the node device carries an identifier request number field, and in a case that a value of the identifier request number field is 100, the number of temporary identifiers in the response message returned by the AMF is 100.

In some exemplary embodiments, in a case that the request message from the node device carries the identity identification information of the node device, the AMF determines the type, capabilities and the like of the node device based on the identity identification information of the node device and then determines the number of temporary identifiers transmitted to the node device based on the above information.

In some embodiments, the node device includes any one of a local AMF, a RAN, or a relay terminal.

In some exemplary embodiments, in a case that the node device is the local AMF, the request message and the response message are messages transmitted over a non-access stratum (NAS) message. For example, the local AMF is mobile, the local AMF may internally include functions of an active terminal, the local AMF transmits the request message to the AMF over the NAS message and the AMF returns the response message to the local AMF over the NAS message.

In some exemplary embodiments, in a case that the node device is the local AMF, the request message and the response message are messages transmitted over a wired connection between the local AMF and the AMF. For example, the local AMF is fixed, the local AMF may be connected to the AMF in a wired manner, the local AMF transmits the request message to the AMF over the wired connection and the AMF returns the response message to the local AMF over the wired connection.

In some exemplary embodiments, in a case that the node device is the RAN, the request message and the response message are messages transmitted over the NAS message. For example, the RAN is mobile, the RAN may internally include functions of an active terminal, the RAN transmits the request message to the AMF over the NAS message and the AMF returns the response message to the RAN over the NAS message.

In some exemplary embodiments, in a case that the node device is the RAN, the request message and the response message are messages transmitted over an access stratum (AS) message. For example, the RAN is mobile, the RAN may internally include functions of an active terminal, the RAN transmits the request message to the AMF over the AS message and the AMF returns the response message to the RAN over the AS message.

In some exemplary embodiments, in a case that the node device is the RAN, the request message and the response message are messages transmitted over a wired connection between N2 interfaces between the RAN and the AMF. For example, the RAN is fixed, the RAN may be connected to the AMF over the N2 interfaces in a wired manner, the RAN transmits the request message to the AMF over the wired connection between the N2 interfaces and the AMF returns the response message to the RAN over the wired connection between the N2 interfaces.

In some exemplary embodiments, in a case that the node device is the relay terminal, the request message and the response message are messages transmitted over the NAS message. For example, the relay terminal transmits the request message to the AMF over the NAS message and the AMF returns the response message to the relay terminal over the NAS message.

In some exemplary embodiments, in a case that the node device is the relay terminal, the request message and the response message are messages transmitted over the AS message. For example, the relay terminal transmits the request message to the AMF over the AS message and the AMF returns the response message to the relay terminal over the AS message.

In step 606, the node device separately allocates one of the plurality of temporary identifiers to the terminal device by a first negotiation process between the node device and the terminal device.

Correspondingly, the terminal device receives the temporary identifier separately allocated by the node device by the first negotiation process between the terminal device and the node device.

The first negotiation process is configured for the node device to separately allocate the temporary identifier to the terminal device, and the temporary identifier is one of a plurality of temporary identifiers allocated in bulk by the AMF to the node device.

It may be understood that the first negotiation process is a process of negotiation and interaction between the node device and the terminal device. In a step that the node device is used as a transmitter end and the terminal device is used a receiver end in the first negotiation process, the node device separately allocates one of a plurality of temporary identifiers to the terminal device and the terminal device correspondingly receives the temporary identifier separately allocated by the node device.

In some embodiments, the node device includes any one of a local AMF, a RAN, or a relay terminal.

In some exemplary embodiments, in a case that the node device is the local AMF, the first negotiation process is a registration process initiated by the terminal device to the local AMF over a NAS message. For example, the terminal device transmits a registration request to the local AMF over the NAS message, and upon receiving the registration request, the local AMF transmits registration accept message to the terminal device over the NAS message, wherein the registration accept message carries temporary identifiers. In this way, that the local AMF separately allocates one of a plurality of temporary identifiers to the terminal device by the registration process between the local AMF and the terminal device is realized.

In some exemplary embodiments, in a case that the node device is the RAN, the first negotiation process is a registration process initiated by the terminal device to the RAN over the NAS message. For example, the terminal device transmits a registration request to the RAN over the NAS message, and upon receiving the registration request, the RAN transmits registration accept message to the terminal device over the NAS message, wherein the registration accept message carries temporary identifiers. Thus, separately allocating, by the RAN, one of a plurality of temporary identifiers to the terminal device by the registration process between the RAN and the terminal device is realized.

In some exemplary embodiments, in a case that the node device is the RAN, the first negotiation process is a radio resource control (RRC) connection establishment process initiated by the terminal device to the RAN over an AS message. For example, the terminal device transmits an RRC connection establishment request to the RAN over the AS message, and upon receiving the RRC connection establishment request, the RAN transmits RRC connection establishment acceptance to the terminal device over the AS message, wherein the RRC connection establishment acceptance carries temporary identifiers. In this way, the RAN separately allocates one of a plurality of temporary identifiers to the terminal device by the RRC connection establishment process between the RAN and the terminal device.

In some exemplary embodiments, in a case that the node device is the relay terminal, the first negotiation process is a connection establishment process initiated by the terminal device to the relay terminal over a PC5 connection. For example, the terminal device transmits a connection establishment request to the relay terminal over the PC5 connection, and upon receiving the connection establishment request, the relay terminal transmits a connection establishment response to the terminal device over the PC5 connection, wherein the connection establishment response carries temporary identifiers. In this way, the relay terminal separately allocates one of a plurality of temporary identifiers to the terminal device by the connection establishment process between the relay terminal and the terminal device.

In summary, in the technical solutions according to the embodiments of the present disclosure, the node device transmits the request message to the AMF, and upon receiving the request message from the node device, the AMF transmits the response message carrying the plurality of temporary identifiers to the node device in a case of accepting the request from the node device, such that the AMF can transmit the bulk allocated temporary identifiers to the node device with demands in a targeted manner based on demands of the side of the node device, and hence the accuracy of temporary identifier allocation is improved.

In addition, in the technical solutions according to the embodiments of the present disclosure, the node device may be implemented as the local AMF, the RAN, or the relay terminal, such that the flexibility of temporary identifier allocation is improved.

In addition, in the technical solutions according to the embodiments of the present disclosure, the node device separately allocates the temporary identifier to the terminal device by the first negotiation process between the node device and the terminal device. The first negotiation process may be the registration process, the RRC connection establishment process, the connection establishment process between the terminal devices, or the like, such that the implementation complexity of the temporary identifier allocation is simplified.

Referring to FIG. 7, a flowchart of an identifier reporting method according to some embodiments of the present disclosure is shown. The method may include the following steps.

In step 702, a node device transmits a report message to an AMF, wherein the report message carries a plurality of temporary identifiers, and each temporary identifier has been configured for a corresponding terminal device.

Correspondingly, the AMF receives the report message from the node device.

The node device is a device for connecting the AMF to the terminal device. In some exemplary embodiments, the node device is disposed closer to the terminal device than the AMF. In the embodiments of the present disclosure, the node device includes one of a local AMF, a RAN, or a relay terminal.

The temporary identifier is a clear identifier provided to a communication device (such as the terminal device) in the communication system, and is used to establish a temporary identity of the communication device. In a case that the temporary identifier is used to identify the identity of the communication device, a permanent identity of the communication device will not be revealed. In some exemplary embodiments, the temporary identifier is a GUTI, and the embodiments of the present disclosure do not limit the specific type of the temporary identifier.

In the embodiments of the present disclosure, the report message carries the plurality of temporary identifiers, and each of the plurality of temporary identifiers has been configured for one corresponding terminal device. It may be understood that the temporary identifiers reported by the node device are all temporary identifiers which have been allocated to the terminal devices, and the temporary identifiers are all in one-to-one correspondence with the terminal devices.

In some exemplary embodiments, the report message from the node device carries a temporary identifier a, a temporary identifier b and a temporary identifier c. The temporary identifier a is configured to a terminal device A, the temporary identifier b is configured to a terminal device B, and the temporary identifier c is configured to a terminal device C.

In some embodiments, a method of triggering the node device to transmit the report message to the AMF includes: in a case that a threshold number of unreported temporary identifiers are acquired at the node device, the node device transmits the report message to the AMF, wherein the report message carries the threshold number of temporary identifiers. The above number threshold is predefined in a standard protocol, or is determined independently by the node device based on decision-making behaviors, or is indicated to the node device by other communication devices (such as AMF).

In some embodiments, a method of triggering the node device to transmit the report message to the AMF includes: in a case that the AMF transmits a report request message to the node device, wherein the report request message is configured to request the node device to report the temporary identifiers, upon receiving the report request message, the node device transmits the report message to the AMF, wherein the report message carries unreported temporary identifiers acquired at the current node device.

It may be understood that before the node device transmits the report message, the node device acknowledges a plurality of temporary identifiers that have been configured for the terminal devices, and since the node device reports the temporary identifiers that have been configured for the terminal devices to the AMF, the node device may be considered as a secondary node between the AMF and the terminal device.

Prior to receiving the report message from the node device, the AMF does not acknowledge the temporary identifiers that have been configured for the terminal devices. Based on the report message from the node device, the AMF acknowledges the temporary identifiers that have been configured for the terminal devices, thereby facilitating establishing temporary identities of corresponding terminal devices based on the temporary identifiers in a communication system.

In some exemplary embodiments, the report message is a bulk ID report message.

In some embodiments, the terminal device is a passive terminal. That is, the identifier reporting method according to the embodiments of the present disclosure is an identifier reporting method for the passive terminal.

In summary, in the technical solution according to the embodiments, in a case that the node device acknowledges the plurality of temporary identifiers that have been configured for the terminal devices, the node device can transmit the report message carrying the plurality of temporary identifiers to the AMF, such that bulk temporary identifiers reporting is achieved, and hence the AMF acknowledges the temporary identifiers that have been configured for the terminal devices, thereby facilitating establishing temporary identities of corresponding terminal devices based on the temporary identifiers in the communication system.

In some exemplary embodiments, before transmitting the report message, the node device is enabled to acknowledge a temporary identifier that has been configured for the terminal device by a negotiation process between the terminal device and the node device.

In some embodiments, the above negotiation process is a first negotiation process, and the first negotiation process is configured for the node device to separately allocate the temporary identifier to the terminal device, and the temporary identifier is one of a plurality of temporary identifiers allocated in bulk by the AMF to the node device.

That is, the temporary identifier of the terminal device is allocated hierarchically over the node device. Before the node device transmits the report message, the AMF allocates in bulk a plurality of temporary identifiers to the node device and then the node device separately allocates the temporary identifier to the terminal device, as shown in FIG. 5 and FIG. 6. Please refer to the embodiment shown in FIG. 8 for details.

In some embodiments, the above negotiation process is a second negotiation process, wherein the second negotiation process is configured for the node device to acquire the temporary identifier which is configured in advance for the terminal device.

That is, the temporary identifier has been has been configured in advance for the terminal device. For example, the terminal device has acquired the configuration of the temporary identifier when it leaves the factory. Before the node device transmits the report message, the terminal device reports its own temporary identifier to the node device. Please be referred to as the embodiment shown in FIG. 9 for details.

Referring to FIG. 8, a flowchart of an identifier reporting method according to some embodiments of the present disclosure is shown. The method may include the following steps.

In step 802, a first negotiation process between a node device and a terminal device is completed, wherein the first negotiation process is configured for the node device to separately allocate a temporary identifier to the terminal device, and the temporary identifier is one of a plurality of temporary identifiers allocated in bulk by an AMF to the node device.

It may be understood that the first negotiation process is a process of negotiation and interaction between the node device and the terminal device. In a step that the node device is used as a transmitter end and the terminal device is used a receiver end in the first negotiation process, the node device separately allocates one of a plurality of temporary identifiers to the terminal device and the terminal device correspondingly receives the temporary identifier separately allocated by the node device.

In some embodiments, the node device includes any one of a local AMF, a RAN, or a relay terminal.

In some exemplary embodiments, in a case that the node device is the local AMF, the first negotiation process is a registration process initiated by the terminal device to the local AMF over a NAS message. For example, the terminal device transmits a registration request to the local AMF over the NAS message, and upon receiving the registration request, the local AMF transmits registration accept message to the terminal device over the NAS message, wherein the registration accept message carries temporary identifiers. In this way, the local AMF separately allocates one of a plurality of temporary identifiers to the terminal device by the registration process between the local AMF and the terminal device.

In some exemplary embodiments, in a case that the node device is the RAN, the first negotiation process is a registration process initiated by the terminal device to the RAN over the NAS message. For example, the terminal device transmits a registration request to the RAN over the NAS message, and upon receiving the registration request, the RAN transmits registration accept message to the terminal device over the NAS message, wherein the registration accept message carries temporary identifiers. In this way, the RAN separately allocates one of a plurality of temporary identifiers to the terminal device by the registration process between the RAN and the terminal device.

In some exemplary embodiments, in a case that the node device is the RAN, the first negotiation process is an RRC connection establishment process initiated by the terminal device to the RAN over an AS message. For example, the terminal device transmits an RRC connection establishment request to the RAN over the AS message, and upon receiving the RRC connection establishment request, the RAN transmits RRC connection establishment acceptance to the terminal device over the AS message, wherein the RRC connection establishment acceptance carries temporary identifiers. In this way, the RAN separately allocates one of a plurality of temporary identifiers to the terminal by the RRC connection establishment process between the RAN and the terminal device.

In some exemplary embodiments, in a case that the node device is the relay terminal, the first negotiation process is a connection establishment process initiated by the terminal device to the relay terminal over a PC5 connection. For example, the terminal device transmits a connection establishment request to the relay terminal over the PC5 connection, and upon receiving the connection establishment request, the relay terminal transmits a connection establishment response to the terminal device over the PC5 connection, wherein the connection establishment response carries temporary identifiers. In this way, the relay terminal separately allocates one of a plurality of temporary identifiers to the terminal device by the connection establishment process between the relay terminal and the terminal device.

In some embodiments, before step 802, the node device transmits a request message to the AMF, wherein the request message is configured to request the AMF to allocate temporary identifiers in bulk; the AMF receives the request message from the node device; the AMF transmits a response message to the node device, wherein the response message carries a plurality of temporary identifiers; and the node device receives the response message from the AMF. In some exemplary embodiments, the request message is a bulk ID allocation request message. In some exemplary embodiments, the response message is a bulk ID allocation response message.

In some embodiments, the number of temporary identifiers in the response message is determined by the AMF based on an identifier request number carried in the request message, wherein the identifier request number is the number of temporary identifiers requested by the node device; or the number of temporary identifiers in the response message is determined by the AMF based on identity identification information of the node device.

In step 804, the node device transmits a report message to the AMF, wherein the report message carries a plurality of temporary identifiers, and each temporary identifier has been configured for a corresponding terminal device.

Correspondingly, the AMF receives the report message from the node device.

Upon completion of the first negotiation process between a plurality of terminal devices and the node device respectively by the process as shown in step 802, the terminal devices acquire the temporary identifies from the node device, the node device transmits the report message to the AMF, wherein the report message carries a plurality of temporary identifiers, and each temporary identifier has been configured for a corresponding terminal device.

In some embodiments, the node device includes any one of a local AMF, a RAN, or a relay terminal.

In some exemplary embodiments, in a case that the node device is the local AMF, the report message is a message transmitted over a NAS message. For example, the local AMF is mobile, the local AMF may internally include functions of an active terminal, and the local AMF transmits the report message to the AMF over the NAS message.

In some exemplary embodiments, in a case that the node device is the local AMF, the report message is a message transmitted over a wired connection between the local AMF and the AMF. For example, if the local AMF is fixed, the local AMF may be connected to the AMF in a wired manner, and the local AMF transmits the report message to the AMF over the wired connection.

In some exemplary embodiments, in a case that the node device is the RAN, the report message is a message transmitted over the NAS message. For example, the RAN is mobile, the RAN may internally include functions of an active terminal, and the RAN transmits the report message to the AMF over the NAS message.

In some exemplary embodiments, in a case that the node device is the RAN, the report message is a message transmitted over an AS message. For example, the RAN is mobile, the RAN may internally include functions of an active terminal, and the RAN transmits the report message to the AMF over the AS message.

In some exemplary embodiments, in a case that the node device is the RAN, the report message is a message transmitted over a wired connection between N2 interfaces between the RAN and the AMF. For example, the RAN is fixed, the RAN may be connected to the AMF over the N2 interfaces in a wired manner, and the RAN transmits the report message to the AMF over the wired connection between the N2 interfaces.

In some exemplary embodiments, in a case that the node device is the relay terminal, the report message is a message transmitted over the NAS message. For example, the relay terminal transmits the report message to the AMF over the NAS message.

In some exemplary embodiments, in a case that the node device is the relay terminal, the report message is a message transmitted over the AS message. For example, the relay terminal transmits the report message to the AMF over the AS message.

In step 806, the AMF transmits a report response message to the node device, wherein the report response message indicates that the report message has been received.

Correspondingly, the node device receives the report response message from the AMF.

In a case that the AMF receives the report message from the node device, the AMF returns the report response message to the node device to inform the node device that the AMF has received the report message.

In some exemplary embodiments, the report response message is a bulk ID report acknowledgement message.

In some embodiments, the node device includes any one of a local AMF, a RAN, or a relay terminal.

In some exemplary embodiments, in a case that the node device is the local AMF, the report response message is a message transmitted over a NAS message. For example, the local AMF is mobile, the local AMF may internally include functions of an active terminal, and the AMF transmits the report response message to the local AMF over the NAS message.

In some exemplary embodiments, in a case that the node device is the local AMF, the report response message is a message transmitted over a wired connection between the local AMF and the AMF. For example, the local AMF is fixed, the local AMF may be connected to the AMF in a wired manner, and the AMF transmits the report response message to the local AMF over the wired connection.

In some exemplary embodiments, in a case that the node device is the RAN, the report response message is a message transmitted over the NAS message. For example, the RAN is mobile, the RAN may internally include functions of an active terminal, and the AMF transmits the report response message to the RAN over the NAS message.

In some exemplary embodiments, in a case that the node device is the RAN, the report response message is a message transmitted over an AS message. For example, the RAN is mobile, the RAN may internally include functions of an active terminal, and the AMF transmits the report response message to the RAN over the AS message.

In some exemplary embodiments, in a case that the node device is the RAN, the report response message is a message transmitted over a wired connection between N2 interfaces between the RAN and the AMF. For example, the RAN is fixed, the RAN may be connected to the AMF over the N2 interfaces in a wired manner, and the AMF transmits the report response message to the RAN over the wired connection between the N2 interfaces.

In some exemplary embodiments, in a case that the node device is the relay terminal, the report response message is a message transmitted over the NAS message. For example, the AMF transmits the report response message to the relay terminal over the NAS message.

In some exemplary embodiments, in a case that the node device is the relay terminal, the report response message is a message transmitted over the AS message. For example, the AMF transmits the report response message to the relay terminal over the AS message.

In summary, in the technical solution according to the embodiments of the present disclosure, before the node device reports in bulk the temporary identifiers that have been configured for the terminal devices over the report message, the AMF allocates in bulk the plurality of temporary identifiers to the node device and then the node device separately allocates the temporary identifier to the terminal device, that is, the temporary identifier of the terminal device is allocated by the AMF and the node device hierarchically. Thus, an implementation method for establishing temporary identities of corresponding terminal devices based on the temporary identifiers in a communication system is provided.

Referring to FIG. 9, a flowchart of an identifier reporting method according to some embodiments of the present disclosure is shown. The method may include the following steps.

In step 902, a second negotiation process between a node device and a terminal device is completed, wherein the second negotiation process is configured for the node device to acquire a temporary identifier of the terminal device which is configured in advance.

It may be understood that the second negotiation process is a process of negotiation and interaction between the node device and the terminal device. In a step that the terminal device is used as a transmitter end and the node device is used as a receiver end in the second negotiation process, the terminal device reports its own temporary identifier to the node device, such that the node device acquires the temporary identifier of the terminal device which is configured in advance.

In some embodiments, the node device includes any one of a local AMF, a RAN, or a relay terminal.

In some exemplary embodiments, in a case that the node device is the local AMF, the second negotiation process is a registration process initiated by the terminal device to the local AMF over a NAS message. For example, the terminal device transmits a registration request to the local AMF over the NAS message, wherein the registration request carries the temporary identifier. In this way, the local AMF acquires the temporary identifier of the terminal device which is configured in advance by the registration process between the local AMF and the terminal device.

In some exemplary embodiments, in a case that the node device is the RAN, the second negotiation process is a registration process initiated by the terminal device to the RAN over the NAS message. For example, the terminal device transmits a registration request to the RAN over the NAS message, wherein the registration request carries the temporary identifier. In this way, the RAN acquires the temporary identifier of the terminal device which is configured in advance by the registration process between the RAN and the terminal device.

In some exemplary embodiments, in a case that the node device is the RAN, the second negotiation process is an RRC connection establishment process initiated by the terminal device to the RAN over an AS message. For example, the terminal device transmits an RRC connection establishment request to the RAN over the AS message, wherein the RRC connection establishment request carries the temporary identifier. In this way, the RAN acquires the temporary identifier of the terminal device which is configured in advance by the RRC connection establishment process between the RAN and the terminal device.

In some exemplary embodiments, in a case that the node device is the relay terminal, the second negotiation process is a connection establishment process initiated by the terminal device to the relay terminal over a PC5 connection. For example, the terminal device transmits a connection establishment request to the relay terminal over the PC5 connection, wherein the connection establishment request carries the temporary identifier. In this way, the relay terminal acquires the temporary identifier of the terminal device which is configured in advance by the connection establishment process between the relay terminal and the terminal device.

In step 904, the node device transmits a report message to the AMF, wherein the report message carries a plurality of temporary identifiers, and each of the plurality of temporary identifiers has been configured for a corresponding terminal device.

Correspondingly, the AMF receives the report message from the node device.

Upon completion of the second negotiation process between a plurality of terminal devices and the node device respectively by the process as shown in step 902, the node device acquires the temporary identifiers of the terminal devices configured in advance, the node device transmits the report message to the AMF, wherein the report message carries a plurality of temporary identifiers, and each of the plurality of temporary identifiers has been configured for a corresponding terminal device.

In some embodiments, the node device includes any one of a local AMF, a RAN, or a relay terminal.

In some exemplary embodiments, in a case that the node device is the local AMF, the report message is a message transmitted over a NAS message. For example, the local AMF is mobile, the local AMF may internally include functions of an active terminal, and the local AMF transmits the report message to the AMF over the NAS message.

In some exemplary embodiments, in a case that the node device is the local AMF, the report message is a message transmitted over a wired connection between the local AMF and the AMF. For example, the local AMF is fixed, the local AMF may be connected to the AMF in a wired manner, and the local AMF transmits the report message to the AMF over the wired connection.

In some exemplary embodiments, in a case that the node device is the RAN, the report message is a message transmitted over the NAS message. For example, the RAN is mobile, the RAN may internally include functions of an active terminal, and the RAN transmits the report message to the AMF over the NAS message.

In some exemplary embodiments, in a case that the node device is the RAN, the report message is a message transmitted over an AS message. For example, the RAN is mobile, the RAN may internally include functions of an active terminal, and the RAN transmits the report message to the AMF over the AS message.

In some exemplary embodiments, in a case that the node device is the RAN, the report message is a message transmitted over a wired connection between N2 interfaces between the RAN and the AMF. For example, the RAN is fixed, the RAN may be connected to the AMF over the N2 interfaces in a wired manner, and the RAN transmits the report message to the AMF over the wired connection between the N2 interfaces.

In some exemplary embodiments, in a case that the node device is the relay terminal, the report message is a message transmitted over the NAS message. For example, the relay terminal transmits the report message to the AMF over the NAS message.

In some exemplary embodiments, in a case that the node device is the relay terminal, the report message is a message transmitted over the AS message. For example, the relay terminal transmits the report message to the AMF over the AS message.

In step 906, the AMF transmits a report response message to the node device, wherein the report response message indicates that the report message has been received.

Correspondingly, the node device receives the report response message from the AMF.

In a case that the AMF receives the report message from the node device, the AMF returns the report response message to the node device to inform the node device that the AMF has received the report message.

In some exemplary embodiments, the report response message is a bulk ID report acknowledgement message.

In some embodiments, the node device includes any one of a local AMF, a RAN, or a relay terminal.

In some exemplary embodiments, in a case that the node device is the local AMF, the report response message is a message transmitted over a NAS message. For example, the local AMF is mobile, the local AMF may internally include functions of an active terminal, and the AMF transmits the report response message to the local AMF over the NAS message.

In some exemplary embodiments, in a case that the node device is the local AMF, the report message is a message transmitted over a wired connection between the local AMF and the AMF. For example, the local AMF is fixed, the local AMF may be connected to the AMF in a wired manner, and the AMF transmits the report response message to the local AMF over the wired connection.

In some exemplary embodiments, in a case that the node device is the RAN, the report response message is a message transmitted over the NAS message. For example, the RAN is mobile, the RAN may internally include functions of an active terminal, and the AMF transmits the report response message to the RAN over the NAS message.

In some exemplary embodiments, in a case that the node device is the RAN, the report response message is a message transmitted over an AS message. For example, the RAN is mobile, the RAN may internally include functions of an active terminal, and the AMF transmits the report response message to the RAN over the AS message.

In some exemplary embodiments, in a case that the node device is the RAN, the report response message is a message transmitted over a wired connection between N2 interfaces between the RAN and the AMF. For example, the RAN is fixed, the RAN may be connected to the AMF over the N2 interfaces in a wired manner, and the AMF transmits the report response message to the RAN over the wired connection between the N2 interfaces.

In some exemplary embodiments, in a case that the node device is the relay terminal, the report response message is a message transmitted over the NAS message. For example, the AMF transmits the report response message to the relay terminal over the NAS message.

In some exemplary embodiments, in a case that the node device is the relay terminal, the report response message is a message transmitted over the AS message. For example, the AMF transmits the report response message to the relay terminal over the AS message.

In summary, in the technical solution according to the embodiments of the present disclosure, before the node device reports in bulk the temporary identifiers that have been configured for the terminal devices over the report message, the terminal devices report their own temporary identifiers to the node device, that is, the temporary identifiers of the terminal devices have been configured in advance, thereby providing an implementation method for establishing temporary identities of corresponding terminal devices based on the temporary identifiers in a communication system.

In some exemplary embodiments, referring to FIG. 10, an identifier allocating and reporting method according to the present disclosure is described below. In the embodiments, a local AMF requests in bulk temporary identifiers from an AMF, and upon allocating the temporary identifiers from the AMF to terminal devices, the local AMF reports in bulk a plurality of temporary identifiers which have been configured for the terminal devices to the AMF. The method may include the following steps.

In step 1002, the local AMF transmits a request message to the AMF.

Correspondingly, the AMF receives the request message from the local AMF.

The request message is configured to request the AMF to allocate temporary identifiers in bulk.

In step 1004, the AMF transmits a response message to the local AMF.

Correspondingly, the local AMF receives the response message from the AMF.

The response message carries a plurality of temporary identifiers.

In some embodiments, the local AMF is mobile, the local AMF may internally include functions of an active terminal, and the local AMF transmits the request message to the AMF over a NAS message and the AMF returns the response message to the local AMF over a NAS message.

In some embodiments, the local AMF is fixed, the local AMF may be connected to the AMF in a wired manner, and the local AMF transmits the request message to the AMF over a wired connection and the AMF returns the response message to the local AMF over the wired connection.

In some embodiments, before step 1004, the AMF determines the number of temporary identifiers transmitted to the node device by the following steps: the AMF determines the number of temporary identifiers in the response message based on an identifier request number carried in the request message, wherein the identifier request number is the number of temporary identifiers requested by the node device; or the AMF determines the number of temporary identifiers in the response message based on identity identification information of the node device.

In step 1006, the terminal device transmits a registration request to the local AMF.

Correspondingly, the local AMF receives the registration request transmitted over the terminal device. In some exemplary embodiments, the terminal device initiates a registration process to the local AMF over a NAS message.

In step 1008, the local AMF transmits a registration accept message to the terminal device.

Correspondingly, the terminal device receives the registration accept message from the local AMF.

The registration accept message carries the temporary identifier separately allocated by the local AMF to the terminal device and this temporary identifier is one of the plurality of temporary identifiers carried in the response message in step 1004.

In step 1010, the local AMF transmits a report message to the AMF.

Correspondingly, the AMF receives the report message transmitted over the local AMF.

The report message carries a plurality of temporary identifiers, and each temporary identifier has been configured for a corresponding terminal device. That is, when a plurality of terminal devices are registered to the local AMF, the local AMF initiates the report message to the AMF, wherein the report message carries the temporary identifier that has been allocated to the terminal device.

In some embodiments, the local AMF is mobile, the local AMF may internally include functions of an active terminal, and the local AMF transmits the report message to the AMF over a NAS message.

In some embodiments, the local AMF is fixed, the local AMF may be connected to the AMF in a wired manner, and the local AMF transmits the report message to the AMF over a wired connection.

In step 1012, the AMF transmits a report response message to the local AMF.

Correspondingly, the local AMF receives the report response message from the AMF.

The report response message indicates that the report message has been received.

In some embodiments, the local AMF is mobile, the local AMF may internally include functions of an active terminal, and the AMF transmits the report response message to the local AMF over a NAS message.

In some embodiments, the local AMF is fixed, the local AMF may be connected to the AMF in a wired manner, and the AMF transmits the report response message to the local AMF over the wired connection.

In summary, in the technical solution according to the embodiments, the hierarchical control identifier allocation method in which the local AMF is used as the node device is provided. By this method, unified management of the temporary identifiers of a plurality of terminal devices is achieved, and the efficiency of the temporary identifier allocation is improved. In addition, the deployment of the local AMF can be optimized based on the locations of the terminal devices.

In some exemplary embodiments, referring to FIG. 11, an identifier allocating and reporting method according to the present disclosure is described below. In the embodiments, a RAN requests in bulk temporary identifiers from an AMF, and after the RAN allocates the temporary identifiers from the AMF to terminal devices, the RAN reports in bulk a plurality of temporary identifiers which have been configured for the terminal devices to the AMF. The method may include the following steps.

In step 1102, the RAN transmits a request message to the AMF.

Correspondingly, the AMF receives the request message from the RAN.

The request message is configured to request the AMF to allocate temporary identifiers in bulk.

In step 1104, the AMF transmits a response message to the RAN.

Correspondingly, the RAN receives the response message from the AMF.

The response message carries a plurality of temporary identifiers.

In some embodiments, the RAN is mobile, the RAN may internally include functions of an active terminal, and the RAN transmits the request message to the AMF over a NAS message and the AMF returns the response message to the RAN over a NAS message.

In some embodiments, the RAN is mobile, the RAN may internally include functions of an active terminal, and the RAN transmits the request message to the AMF over an AS message and the AMF returns the response message to the RAN over an AS message.

In some embodiments, the RAN is fixed, the RAN may be connected to the AMF over N2 interfaces in a wired manner, and the RAN transmits the request message to the AMF over a wired connection between the N2 interfaces and the AMF returns the response message to the RAN over the wired connection between the N2 interfaces.

In some embodiments, before step 1104, the AMF determines the number of temporary identifiers to be transmitted to the node device by the following steps: the AMF determines the number of temporary identifiers in the response message based on an identifier request number carried in the request message, wherein the identifier request number is the number of temporary identifiers requested by the node device; or the AMF determines the number of temporary identifiers in the response message based on identity identification information of the node device.

In step 1106, the terminal device transmits a registration request to the RAN.

Correspondingly, the RAN receives the registration request transmitted over the terminal device. In some exemplary embodiments, the terminal device initiates a registration process to the RAN over a NAS message.

In step 1108, the RAN transmits registration accept message to the terminal device.

Correspondingly, the terminal device receives the registration accept message transmitted over the RAN.

The registration accept message carries the temporary identifier separately allocated by the RAN to the terminal device and this temporary identifier is one of the plurality of temporary identifiers carried in the response message in step 1104.

It may be understood that the RAN may separately allocate the temporary identifier to the terminal device by an RRC connection establishment process initiated over an AS message in addition to the registration process shown in step 1106 to step 1108.

In step 1110, the RAN transmits a report message to the AMF.

Correspondingly, the AMF receives the report message from the RAN.

The report message carries a plurality of temporary identifiers, and each of the plurality of temporary identifiers has been configured for a corresponding terminal device. That is, after a plurality of terminal devices are registered to the RAN, the RAN initiates the report message to the AMF, wherein the report message carries the temporary identifiers that have been allocated to the terminal devices.

In some embodiments, the RAN is mobile, the RAN may internally include functions of an active terminal, and the RAN transmits the report message to the AMF over a NAS message.

In some embodiments, the RAN is mobile, the RAN may internally include functions of an active terminal and the RAN transmits the report message to the AMF over an AS message.

In some embodiments, the RAN is fixed, the RAN may be connected to the AMF over N2 interfaces in a wired manner, and the RAN transmits the report message to the AMF over a wired connection between the N2 interfaces.

In step 1112, the AMF transmits a report response message to the RAN.

Correspondingly, the RAN receives the report response message from the AMF.

The report response message indicates that the report message has been received.

In some embodiments, the RAN is mobile, the RAN may internally include functions of an active terminal, and the AMF transmits the report response message to the RAN over the NAS message.

In some embodiments, the RAN is mobile, the RAN may internally include functions of an active terminal, and the AMF transmits the report response message to the RAN over the AS message.

In some embodiments, the RAN is fixed, the RAN may be connected to the AMF over the N2 interfaces in a wired manner, and the AMF transmits the report response message to the RAN over the wired connection between the N2 interfaces.

In summary, in the technical solution according to the embodiments, the hierarchical control identifier allocation method in which the RAN is used as the node device is provided. By performing this method, unified management of the temporary identifiers of a plurality of terminal devices is achieved, and the efficiency of the temporary identifier allocation is improved. In addition, the deployment of the RAN can be optimized based on the locations of the terminal devices.

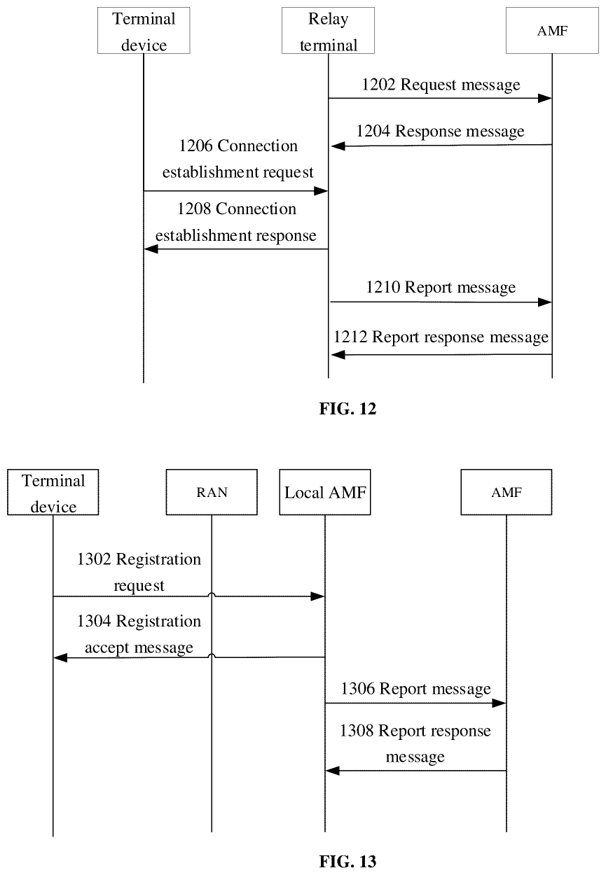

In some exemplary embodiments, referring to FIG. 12, an identifier allocating and reporting method according to the present disclosure is described below. In the embodiments, a relay terminal requests in bulk temporary identifiers from an AMF, and upon allocating the temporary identifiers from the AMF to terminal devices, the relay terminal reports in bulk a plurality of temporary identifiers which have been configured for the terminal devices to the AMF. The method may include the following steps.

In step 1202, the relay terminal transmits a request message to the AMF.

Correspondingly, the AMF receives the request message from the relay terminal.

The request message is configured to request the AMF to allocate temporary identifiers in bulk.

In step 1204, the AMF transmits a response message to the relay terminal.

Correspondingly, the relay terminal receives the response message from the AMF.

The response message carries a plurality of temporary identifiers.

In some embodiments, the relay terminal transmits the request message to the AMF over a NAS message and the AMF returns the response message to the relay terminal over a NAS message.

In some embodiments, the relay terminal transmits the request message to the AMF over an AS message and the AMF returns the response message to the relay terminal over an AS message.

In some embodiments, before step 1204, the AMF determines the number of temporary identifiers to be transmitted to the node device by the following steps: the AMF determines the number of temporary identifiers in the response message based on an identifier request number carried in the request message, wherein the identifier request number is the number of temporary identifiers requested by the node device; or the AMF determines the number of temporary identifiers in the response message based on identity identification information of the node device.

In step 1206, the terminal device transmits a connection establishment request to the relay terminal.

Correspondingly, the relay terminal receives the connection establishment request transmitted over the terminal device. In some exemplary embodiments, the terminal device establishes a PC5 connection with the relay terminal.

In step 1208, the relay terminal transmits a connection establishment response to the terminal device.

Correspondingly, the terminal device receives the connection establishment response transmitted over the relay terminal.

The connection establishment response carries the temporary identifier separately allocated by the relay terminal to the terminal device and this temporary identifier is one of the plurality of temporary identifiers carried in the response message in step 1204.

In step 1210, the relay terminal transmits a report message to the AMF.

Correspondingly, the AMF receives the report message transmitted over the relay terminal.

The report message carries a plurality of temporary identifiers, and each temporary identifier has been configured for a corresponding terminal device. That is, upon establishing the PC5 connection between a plurality of terminal devices and the relay terminal, the relay terminal transmits the report message to the AMF, wherein the report message carries the temporary identifiers that have been allocated to the terminal devices.

In some embodiments, the relay terminal transmits the report message to the AMF over a NAS message.

In some embodiments, the relay terminal transmits the report message to the AMF over an AS message.

In step 1212, the AMF transmits a report response message to the relay terminal.

Correspondingly, the relay terminal receives the report response message from the AMF.

The report response message indicates that the report message has been received.

In some embodiments, the AMF transmits the report response message to the relay terminal over a NAS message.

In some embodiments, the AMF transmits the report response message to the relay terminal over an AS message.

In summary, in the technical solution according to the embodiments, the hierarchical control identifier allocation method in which the relay terminal is used as the node device is provided. By performing this method, unified management of the temporary identifiers of a plurality of terminal devices is achieved, and the efficiency of temporary identifier allocation is improved. In addition, the deployment of the relay terminal can be optimized based on the locations of the terminal devices.

In some exemplary embodiments, referring to FIG. 13, an identifier allocating and reporting method according to the present disclosure is described below. In the embodiments, temporary identifiers of terminal devices have been configured in advance, the terminal devices notify a local AMF of the temporary identifiers, and the local AMF reports in bulk the temporary identifiers of a plurality of terminal devices to an AMF. The method may include the following steps.

In step 1302, the terminal device transmits a registration request to the local AMF.

Correspondingly, the local AMF receives the registration request transmitted over the terminal device. In some exemplary embodiments, the terminal device initiates a registration process to the local AMF over a NAS message.

The registration request carries the temporary identifier of the terminal device that has been configured in advance.

In step 1304, the local AMF transmits registration accept message to the terminal device.

Correspondingly, the terminal device receives the registration accept message transmitted over the local AMF.

In step 1306, the local AMF transmits a report message to the AMF.

Correspondingly, the AMF receives the report message transmitted over the local AMF.

The report message carries a plurality of temporary identifiers, and each temporary identifier has been configured for a corresponding terminal device. That is, after a plurality of terminal devices are registered to the local AMF, the local AMF initiates the report message to the AMF, wherein the report message carries the temporary identifiers that have been allocated to the terminal devices.

In some embodiments, the local AMF is mobile, the local AMF may internally include functions of an active terminal, and the local AMF transmits the report message to the AMF over a NAS message.

In some embodiments, the local AMF is fixed, the local AMF may be connected to the AMF in a wired manner, and the local AMF transmits the report message to the AMF over a wired connection.

In step 1308, the AMF transmits a report response message to the local AMF.

Correspondingly, the local AMF receives the report response message from the AMF.

The report response message indicates that the report message has been received.

In some embodiments, the local AMF is mobile, the local AMF may internally include functions of an active terminal, and the AMF transmits the report response message to the local AMF over a NAS message.

In some embodiments, the local AMF is fixed, the local AMF may be connected to the AMF in a wired manner, and the AMF transmits the report response message to the local AMF over the wired connection.

In summary, in the technical solution according to the embodiments, the hierarchical control identifier allocation method in which the local AMF is used as the node device is provided. By this method, unified management of the temporary identifiers of a plurality of terminal devices is achieved, and the efficiency of the temporary identifier allocation is improved. In addition, the deployment of the local AMF can be optimized based on the locations of the terminal devices.

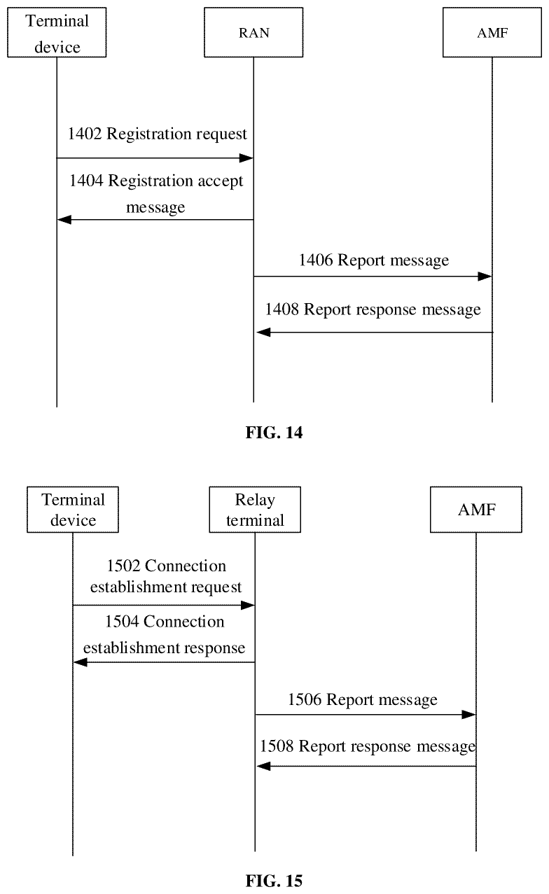

In some exemplary embodiments, referring to FIG. 14, an identifier allocating and reporting method according to the present disclosure is described below. In the embodiments, temporary identifiers of terminal devices have been configured in advance, the terminal devices notify a RAN of the temporary identifiers, and the RAN reports in bulk the temporary identifiers of a plurality of terminal devices to an AMF. The method may include the following steps.

In step 1402, the terminal device transmits a registration request to the RAN.

Correspondingly, the RAN receives the registration request transmitted over the terminal device. In some exemplary embodiments, the terminal device initiates a registration process to the RAN over a NAS message.

The registration request carries the temporary identifier of the terminal device that has been configured in advance.

In step 1404, the RAN transmits registration accept message to the terminal device.

Correspondingly, the terminal device receives the registration accept message transmitted over the RAN.

It may be understood that the RAN may acknowledge the temporary identifier of the terminal device over an RRC connection establishment process initiated over an AS message in addition to the registration process shown in step 1402 and step 1404.

In step 1406, the RAN transmits a report message to the AMF.

Correspondingly, the AMF receives the report message transmitted over the RAN.

The report message carries a plurality of temporary identifiers, and each temporary identifier has been configured for a corresponding terminal device. That is, after a plurality of terminal devices are registered to the RAN, the RAN initiates the report message to the AMF, wherein the report message carries the temporary identifiers that have been allocated to the terminal devices.

In some embodiments, the RAN is mobile, the RAN may internally include functions of an active terminal, and the RAN transmits the report message to the AMF over a NAS message.

In some embodiments, the RAN is mobile, the RAN may internally include functions of an active terminal, and the RAN transmits the report message to the AMF over an AS message.

In some embodiments, the RAN is fixed, the RAN may be connected to the AMF over N2 interfaces in a wired manner, and the RAN transmits the report message to the AMF over a wired connection between the N2 interfaces.

In step 1408, the AMF transmits a report response message to the RAN.

Correspondingly, the RAN receives the report response message from the AMF.

The report response message indicates that the report message has been received.

In some embodiments, the RAN is mobile, the RAN may internally include functions of an active terminal, and the AMF transmits the report response message to the RAN over a NAS message.

In some embodiments, the RAN is mobile, the RAN may internally include functions of an active terminal, and the AMF transmits the report response message to the RAN over an AS message.

In some embodiments, the RAN is fixed, the RAN may be connected to the AMF over the N2 interfaces in a wired manner, and the AMF transmits the report response message to the RAN over the wired connection between the N2 interfaces.

In summary, in the technical solution according to the embodiments, the hierarchical control identifier allocation method in which the RAN is used as the node device is provided. By performing this method, unified management of the temporary identifiers of a plurality of terminal devices is achieved, and the efficiency of temporary identifier allocation is improved. In addition, the deployment of the local AMF can be optimized based on the locations of the terminal devices.

In some exemplary embodiments, referring to FIG. 15, an identifier allocating and reporting method according to the present disclosure is described below. In the embodiments, temporary identifiers of terminal devices have been configured in advance, the terminal devices notify a relay terminal of the temporary identifiers, and the relay terminal reports in bulk the temporary identifiers of a plurality of terminal devices to an AMF. The method may include the following steps.

In step 1502, the terminal device transmits a connection establishment request to the relay terminal.

Correspondingly, the relay terminal receives the connection establishment request transmitted over the terminal device. In some exemplary embodiments, the terminal device establishes a PC5 connection with the relay terminal.

The connection establishment request carries the temporary identifier of the terminal device that has been configured in advance.

In step 1504, the relay terminal transmits a connection establishment response to the terminal device.

Correspondingly, the terminal device receives the connection establishment response transmitted over the relay terminal.

In step 1506, the relay terminal transmits a report message to the AMF.

Correspondingly, the AMF receives the report message transmitted over the relay terminal.

The report message carries a plurality of temporary identifiers, and each temporary identifier has been configured for a corresponding terminal device. That is, after a plurality of terminal devices establish the PC5 connection with the relay terminal, the relay terminal initiates the report message to the AMF, wherein the report message carries the temporary identifiers that have been allocated to the terminal device.

In some embodiments, the relay terminal transmits the report message to the AMF over a NAS message.

In some embodiments, the relay terminal transmits the report message to the AMF over an AS message.

In step 1508, the AMF transmits a report response message to the relay terminal.

Correspondingly, the relay terminal receives the report response message from the AMF.

The report response message indicates that the report message has been received.

In some embodiments, the AMF transmits the report response message to the relay terminal over a NAS message.

In some embodiments, the AMF transmits the report response message to the relay terminal over an AS message.

In summary, in the technical solution according to the embodiments, the hierarchical control identifier allocation method in which the relay terminal is used as the node device is provided. By performing this method, unified management of the temporary identifiers of a plurality of terminal devices is achieved, and the efficiency of temporary identifier allocation is improved. In addition, the deployment of the relay terminal can be optimized based on the locations of the terminal devices.

It may be understood that the above method embodiments can be implemented separately or in a combined manner, which is not limited in the present disclosure.

The followings describe the apparatus embodiments of the present disclosure for implementing the method embodiments of the present disclosure. For details that are not disclosed in the apparatus embodiments of the present disclosure, reference is made to the method embodiments of the present disclosure.

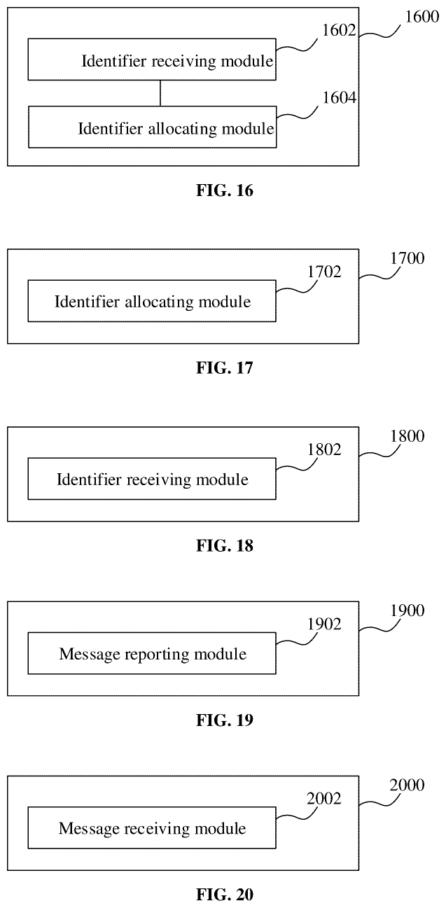

Referring to FIG. 16, a block diagram of an identifier allocation apparatus according to some embodiments of the present disclosure is shown, this apparatus has a function of implementing the method examples at the side of the node device. The function may be implemented by hardware or by hardware executing corresponding software. The apparatus may be a node device described above, or may be provided in the node device. The apparatus is an apparatus for connecting an AMF to a terminal device. As shown in FIG. 16, the apparatus 1600 may include an identifier receiving module 1602 and an identifier allocating module 1604.

The identifier receiving module 1602 is configured to receive a plurality of temporary identifiers allocated in bulk by the AMF.

The identifier allocating module 1604 is configured to separately allocate one of the plurality of temporary identifiers to the terminal device.

In some embodiments, the apparatus further includes a request transmitting module, wherein
the request transmitting module is configured to transmit a request message to the AMF, wherein the request message is configured to request the AMF to allocate the temporary identifiers in bulk; and
the identifier receiving module 1602 is configured to receive a response message from the AMF, wherein the response message carries the plurality of temporary identifiers.

In some embodiments, the apparatus includes any one of a local AMF, a RAN, or a relay terminal; wherein
in a case that the apparatus is the local AMF, the request message and the response message are messages transmitted over a NAS message; or
in a case that the apparatus is the local AMF, the request message and the response message are messages transmitted over a wired connection between the local AMF and the AMF; or
in a case that the apparatus is the RAN, the request message and the response message are messages transmitted over the NAS message; or
in a case that the apparatus is the RAN, the request message and the response message are messages transmitted over an AS message; or
in a case that the apparatus is the RAN, the request message and the response message are messages transmitted over a wired connection between N2 interfaces between the RAN and the AMF; or
in a case that the apparatus is the relay terminal, the request message and the response message are messages transmitted over the NAS message; or
in a case that the apparatus is the relay terminal, the request message and the response message are messages transmitted over the AS message.

In some embodiments, the number of temporary identifiers in the response message is determined by the AMF based on an identifier request number carried in the request message, and the identifier request number is the number of temporary identifiers requested by the apparatus; or
the number of temporary identifiers in the response message is determined by the AMF based on identity identification information of the apparatus.

In some embodiments, the identifier allocating module 1604 is configured to separately allocate one of the plurality of temporary identifiers to the terminal device by a first negotiation process between the apparatus and the terminal device.

In some embodiments, the apparatus includes any one of a local AMF, a radio access network (RAN) or a relay terminal; wherein
in a case that the apparatus is the local AMF, the first negotiation process is a registration process initiated by the terminal device to the local AMF over a NAS message; or
in a case that the apparatus is the RAN, the first negotiation process is a registration process initiated by the terminal device to the RAN over the NAS message; or
in a case that the apparatus is the RAN, the first negotiation process is an RRC connection establishment process initiated by the terminal device to the RAN over an AS message; or
in a case that the apparatus is the relay terminal, the first negotiation process is a connection establishment process initiated by the terminal device to the relay terminal over a PC5 connection.

In some embodiments, the terminal device is a passive terminal.

Referring to FIG. 17, a block diagram of an identifier allocation apparatus according to some embodiments of the present disclosure is shown. This apparatus has a function of implementing the method examples at the side of the AMF. The function may be implemented by hardware or by hardware executing corresponding software. The apparatus may be an AMF described above, or may be provided in the AMF. As shown in FIG. 17, the apparatus 1700 may include an identifier allocating module 1702.

The identifier allocating module 1702 is configured to transmit a plurality of temporary identifiers allocated in bulk to a node device, to cause the node device to separately allocate one of the plurality of temporary identifiers to a terminal device, wherein the node device is a device for connecting the apparatus to the terminal device.

In some embodiments, the apparatus further includes a request receiving module, wherein
the request receiving module is configured to receive a request message from the node device, wherein the request message is configured to request the apparatus to allocate the plurality of temporary identifiers in bulk; and
the identifier allocating module 1702 is configured to transmit a response message to the node device, wherein the response message carries the plurality of temporary identifiers.

In some embodiments, the node device includes any one of a local AMF, a RAN, or a relay terminal; wherein
in a case that the node device is the local AMF, the request message and the response message are messages transmitted over a NAS message; or
in a case that the node device is the local AMF, the request message and the response message are messages transmitted over a wired connection between the local AMF and the apparatus; or
in a case that the node device is the RAN, the request message and the response message are messages transmitted over the NAS message; or
in a case that the node device is the RAN, the request message and the response message are messages transmitted over an AS message; or
in a case that the node device is the RAN, the request message and the response message are messages transmitted over a wired connection between N2 interfaces between the RAN and the apparatus; or
in a case that the node device is the relay terminal, the request message and the response message are messages transmitted over the NAS message; or
in a case that the node device is the relay terminal, the request message and the response message are messages transmitted over the AS message.

In some embodiments, the apparatus further includes a number determining module; wherein
the number determining module is configured to determine the number of temporary identifiers in the response message based on an identifier request number carried in the request message, wherein the identifier request number is the number of temporary identifiers requested by the node device; or
the number determining module is configured to determine the number of temporary identifiers in the response message based on identity identification information of the node device.

In some embodiments, the terminal device is a passive terminal.

Referring to FIG. 18, a block diagram of an identifier allocation apparatus according to some embodiments of the present disclosure is shown, this apparatus has a function of implementing the method examples at the side of the terminal device. The function may be implemented by hardware or by hardware executing corresponding software. The apparatus may be a terminal device described above, or may be provided in the terminal device. As shown in FIG. 18, the apparatus 1800 may include an identifier receiving module 1802.

The identifier receiving module 1802 is configured to receive a temporary identifier separately allocated by a node device, wherein the node device is a device for connecting an AMF to the apparatus, and the temporary identifier is one of a plurality of temporary identifiers allocated in bulk by the AMF to the node device.

In some embodiments, the identifier receiving module 1802 is configured to receive the temporary identifier separately allocated by the node device by a first negotiation process between the identifier receiving module and the node device.

In some embodiments, the node device includes any one of a local AMF, a RAN, or a relay terminal; wherein
in a case that the node device is the local AMF, the first negotiation process is a registration process initiated by the apparatus to the local AMF over a NAS message; or
in a case that the node device is the RAN, the first negotiation process is a registration process initiated by the apparatus to the RAN over the NAS message; or
in a case that the node device is the RAN, the first negotiation process is an RRC connection establishment process initiated by the apparatus to the RAN over an AS message; or
in a case that the node device is the relay terminal, the first negotiation process is a connection establishment process initiated by the apparatus to the relay terminal over a PC5 connection.

In some embodiments, the apparatus is a passive terminal.

Referring to FIG. 19, a block diagram of an identifier reporting apparatus according to some embodiments of the present disclosure is shown, this apparatus has a function of implementing the method examples at the side of the node device. The function may be implemented by hardware or by hardware executing corresponding software. The apparatus may be a node device described above, or may be provided in the node device. The apparatus is an apparatus for connecting an AMF to a terminal device. As shown in FIG. 19, the apparatus 1900 may include a message reporting module 1902.

The message reporting module 1902 is configured to transmit a report message to the AMF, wherein the report message carries a plurality of temporary identifiers, and each of the plurality of temporary identifiers has been configured for a corresponding terminal device.

In some embodiments, the message reporting module 1902 is configured to transmit the report message to the AMF upon completion of a first negotiation process between the apparatus and a plurality of terminal devices, wherein the first negotiation process is configured for the apparatus to separately allocate the temporary identifier to the terminal device, and the temporary identifier is one of a plurality of temporary identifiers allocated in bulk by the AMF to the apparatus.

In some embodiments, the apparatus includes any one of a local AMF, a RAN, or a relay terminal; wherein
in a case that the apparatus is the local AMF, the first negotiation process is a registration process initiated by the terminal device to the local AMF over a NAS message; or
in a case that the apparatus is the RAN, the first negotiation process is a registration process initiated by the terminal device to the RAN over the NAS message; or
in a case that the apparatus is the RAN, the first negotiation process is an RRC connection establishment process initiated by the terminal device to the RAN over an AS message; or
in a case that the apparatus is the relay terminal, the first negotiation process is a connection establishment process initiated by the terminal device to the relay terminal over a PC5 connection.

In some embodiments, the message reporting module 1902 is configured to transmit the report message to the AMF upon completion of a second negotiation process between the apparatus and a plurality of terminal devices, wherein the second negotiation process is configured for the apparatus to acquire the temporary identifiers of the terminal devices which are configured in advance.

In some embodiments, the apparatus includes any one of a local AMF, a RAN, or a relay terminal; wherein
in a case that the apparatus is the local AMF, the second negotiation process is a registration process initiated by the terminal device to the local AMF over a NAS message; or
in a case that the apparatus is the RAN, the second negotiation process is a registration process initiated by the terminal device to the RAN over the NAS message; or
in a case that the apparatus is the RAN, the second negotiation process is an RRC connection establishment process initiated by the terminal device to the RAN over an AS message; or
in a case that the apparatus is the relay terminal, the second negotiation process is a connection establishment process initiated by the terminal device to the relay terminal over a PC5 connection.

In some embodiments, the apparatus includes any one of a local AMF, a RAN, or a relay terminal; wherein
in a case that the apparatus is the local AMF, the report message is a message transmitted over a NAS message; or
in a case that the apparatus is the local AMF, the report message is a message transmitted over a wired connection between the local AMF and the AMF; or
in a case that the apparatus is the RAN, the report message is a message transmitted over the NAS message; or
in a case that the apparatus is the RAN, the report message is a message transmitted over an AS message; or
in a case that the apparatus is the RAN, the report message is a message transmitted over a wired connection between N2 interfaces between the RAN and the AMF; or
in a case that the apparatus is the relay terminal, the report message is a message transmitted over the NAS message; or
in a case that the apparatus is the relay terminal, the report message is a message transmitted over the AS message.

In some embodiments, the apparatus further includes a response receiving module.

The response receiving module is configured to receive a report response message from the AMF, wherein the report response message indicates that the report message has been received.

In some embodiments, the apparatus includes any one of a local AMF, a RAN, or a relay terminal; wherein
in a case that the apparatus is the local AMF, the report response message is a message transmitted over a NAS message; or
in a case that the apparatus is the local AMF, the report message is a message transmitted over a wired connection between the local AMF and the AMF; or
in a case that the apparatus is the RAN, the report response message is a message transmitted over the NAS message; or
in a case that the apparatus is the RAN, the report response message is a message transmitted over an AS message; or
in a case that the apparatus is the RAN, the report response message is a message transmitted over a wired connection between N2 interfaces between the RAN and the AMF; or
in a case that the apparatus is the relay terminal, the report response message is a message transmitted over the NAS message; or
in a case that the apparatus is the relay terminal, the report response message is a message transmitted over the AS message.

In some embodiments, the terminal device is a passive terminal.

Referring to FIG. 20, a block diagram of an identifier report apparatus according to some embodiments of the present disclosure is shown, this apparatus has a function of implementing the method examples at the side of the AMF. The function may be implemented by hardware or by hardware executing corresponding software. The apparatus may be an AMF as described above, or may be provided in the AMF. As shown in FIG. 20, the apparatus 2000 may include a message receiving module 2002.

The message receiving module 2002 is configured to receive a report message from a node device, wherein the report message carries a plurality of temporary identifiers, each of the plurality of temporary identifiers has been configured for a corresponding terminal device, and the node device is a device for connecting the apparatus to the terminal device.

In some embodiments, the node device includes any one of a local AMF, a RAN, or a relay terminal; wherein
in a case that the node device is the local AMF, the report message is a message transmitted over a NAS message; or
in a case that the node device is the local AMF, the report message is a message transmitted over a wired connection between the local AMF and the apparatus; or
in a case that the node device is the RAN, the report message is a message transmitted over the NAS message; or
in a case that the node device is the RAN, the report message is a message transmitted over an AS message; or
in a case that the node device is the RAN, the report message is a message transmitted over a wired connection between N2 interfaces between the RAN and the apparatus; or
in a case that the node device is the relay terminal, the report message is a message transmitted over the NAS message; or
in a case that the node device is the relay terminal, the report message is a message transmitted over the AS message.

In some embodiments, the apparatus further includes a response transmitting module.

The response transmitting module is configured to transmit a report response message to the node device, wherein the report response message indicates that the report message has been received.

In some embodiments, the node device includes any one of a local AMF, a RAN, or a relay terminal;
in a case that the node device is the local AMF, the report response message is a message transmitted over a NAS message; or
in a case that the node device is the local AMF, the report response message is a message transmitted over a wired connection between the local AMF and the apparatus; or
in a case that the node device is the RAN, the report response message is a message transmitted over the NAS message; or
in a case that the node device is the RAN, the report response message is a message transmitted over an AS message; or
in a case that the node device is the RAN, the report response message is a message transmitted over a wired connection between N2 interfaces between the RAN and the apparatus; or

in a case that the node device is the relay terminal, the report response message is a message transmitted over the NAS message; or
in a case that the node device is the relay terminal, the report response message is a message transmitted over the AS message.

In some embodiments, the terminal device is a passive terminal.

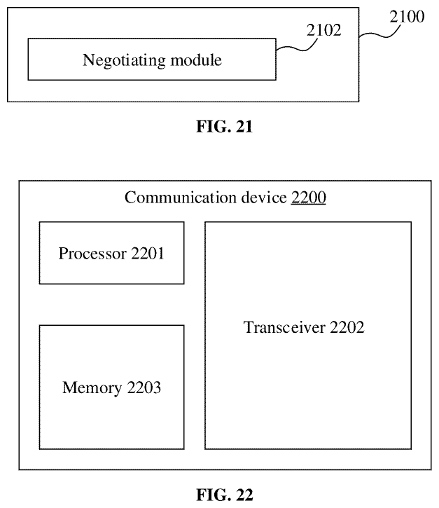

Referring to FIG. 21, a block diagram of an identifier reporting apparatus according to some embodiments of the present disclosure is shown, this apparatus has a function of implementing the method examples at the side of the terminal device. The function may be implemented by hardware or by hardware executing corresponding software. The apparatus may be a terminal device described above, or may be provided in the terminal device. As shown in FIG. 21, the apparatus 2100 may include a negotiating module 2102.
wherein the negotiating module 2102 is configured to enable a node device to acknowledge a temporary identifier that has been configured for the apparatus by a negotiation process between the apparatus and the node device, wherein the node device is a device for connecting an AMF to the apparatus.

In some embodiments, the negotiation process includes a first negotiation process, wherein the first negotiation process is configured for the node device to separately allocate the temporary identifier to the apparatus, and the temporary identifier is one of a plurality of temporary identifiers allocated in bulk by the AMF to the node device.

In some embodiments, the node device includes any one of a local AMF, a RAN, or a relay terminal; wherein
in a case that the node device is the local AMF, the first negotiation process is a registration process initiated by the apparatus to the local AMF over a NAS message; or
in a case that the node device is the RAN, the first negotiation process is a registration process initiated by the apparatus to the RAN over the NAS message; or
in a case that the node device is the RAN, the first negotiation process is an RRC connection establishment process initiated by the apparatus to the RAN over an AS message; or
in a case that the node device is the relay terminal, the first negotiation process is a connection establishment process initiated by the apparatus to the relay terminal over a PC5 connection.

In some embodiments, the negotiation process includes a second negotiation process, wherein the second negotiation process is configured for the node device to acquire the temporary identifier of the apparatus which is configured in advance.

In some embodiments, the node device includes any one of a local AMF, a RAN, or a relay terminal; wherein
in a case that the node device is the local AMF, the second negotiation process is a registration process initiated by the apparatus to the local AMF over a NAS message; or
in a case that the node device is the RAN, the second negotiation process is a registration process initiated by the apparatus to the RAN over the NAS message; or
in a case that the node device is the RAN, the second negotiation process is an RRC connection establishment process initiated by the apparatus to the RAN over an AS message; or
in a case that the node device is the relay terminal, the second negotiation process is a connection establishment process initiated by the apparatus to the relay terminal over a PC5 connection.

In some embodiments, the apparatus is a passive terminal.

It should be noted that the apparatuses according to the above embodiments are only illustrated by the division of various functional modules when implementing their functions. In practice, the functions may be assigned to different functional modules for implementation according to actual needs, that is, the apparatus is divided into different functional modules in terms of internal structure, to implement all or part of the functions described above.

With regard to the apparatuses in the above embodiments, the specific manner in which the respective modules perform the operations has been described in detail in embodiments of the related method, and will not be explained in detail here.

Referring to FIG. 22, a structural schematic diagram of a communication device (a node device or a terminal device or an AMF) according to some embodiments of the present disclosure is shown, the communication device may include a processor 2201, a transceiver 2202 and a memory 2203.

The processor 2201 includes one or more processing cores, and the processor 2201 performs various functional applications by running software programs and modules.

The transceiver 2202 may be configured to receive and transmit information, and the transceiver 2202 may be a communication chip.

The memory 2203 may be configured to store a computer program, and the processor 2201 is configured to execute the computer program to perform various steps executed by the communication device in the above method embodiment.

In addition, the memory 2203 may be implemented by any type of a volatile or non-volatile storage device or a combination thereof. The volatile or non-volatile storage device includes but is not limited to a random-access memory (RAM), a read-only memory (ROM), an erasable programmable read-only memory (EPROM), an electrically erasable programmable read-only memory (EEPROM), a flash memory or other solid-state storage technologies, a compact disc read-only memory (CD-ROM), a digital video disc (DVD) or other optical storage, a tape cartridge, a magnetic tape, a disk storage, or other magnetic storage devices.

When the communication device is implemented as a node device, the processor 2201 and the transceiver 2202 involved in the embodiments of the present disclosure may perform steps performed by the node device in the method shown in any one of FIGS. 5 to 15, which are not described herein any further.

In some embodiments, when the communication device is implemented as the node device, the transceiver 2202 is configured to receive a plurality of temporary identifiers allocated in bulk by the AMF; and
the transceiver 2202 is configured to separately allocate one of the plurality of temporary identifiers to the terminal device.

When the communication device is implemented as the AMF, the processor 2201 and the transceiver 2202 involved in the embodiments of the present disclosure may perform steps performed by the AMF in the method shown in any one of FIGS. 5 to 15, which are not described herein any further.

In some embodiments, when the communication device is implemented as the AMF, the transceiver 2202 is configured to transmit a plurality of temporary identifiers allocated in bulk to a node device, such that the node device separately allocates one of the plurality of temporary identifiers to a terminal device, wherein the node device is a device for connecting the AMF to the terminal device.

When the communication device is implemented as the terminal device, the processor 2201 and the transceiver 2202 involved in the embodiments of the present disclosure may perform steps performed by the terminal device in the method shown in any one of FIGS. 5 to 15, which are not described herein any further.

In some embodiments, when the communication device is implemented as the terminal device,
the transceiver 2202 is configured to receive a temporary identifier separately allocated by a node device, wherein the node device is a device for connecting the AMF to the terminal device, and the temporary identifier is one of a plurality of temporary identifiers allocated in bulk by the AMF to the node device.

When the communication device is implemented as the node device, the processor 2201 and the transceiver 2202 involved in the embodiments of the present disclosure may perform steps performed by the node device in the method shown in any one of FIGS. 5 to 15, which are not described herein any further.

In some embodiments, when the communication device is implemented as the node device, the transceiver 2202 is configured to receive a plurality of temporary identifiers allocated in bulk by the AMF; and
the transceiver 2202 is configured to separately allocate one of the plurality of temporary identifiers to the terminal device.

When the communication device is implemented as the AMF, the processor 2201 and the transceiver 2202 involved in the embodiments of the present disclosure may perform steps performed by the AMF in the method shown in any one of FIGS. 5 to 15, which are not described herein any further.

In some embodiments, when the communication device is implemented as the AMF, the transceiver 2202 is configured to receive a report message from a node device, wherein the report message carries a plurality of temporary identifiers, each of the plurality of temporary identifiers has been configured for a corresponding terminal device, and the node device is a device for connecting the AMF to the terminal device.

When the communication device is implemented as the terminal device, the processor 2201 and the transceiver 2202 involved in the embodiments of the present disclosure may perform steps performed by the terminal device in the method shown in any one of FIGS. 5 to 15, which are not described herein any further.

In some embodiments, when the communication device is implemented as the terminal device,
the transceiver 2202 is configured to enable a node device to acknowledge a temporary identifier that has been configured for the terminal device by a negotiation process between the terminal device and the node device, wherein the node device is a device for connecting an AMF to the terminal device.

Some embodiments of the present disclosure further provide a non-transitory computer-readable storage medium storing a computer program therein. The computer program, when run by a processor, cause the processor to perform the identifier allocation method or the identifier reporting method mentioned above.

In some embodiments, the computer-readable storage medium may include a ROM, RAM, a solid state drive (SSD), an optical disc, or the like. The random-access memory may include a resistance random-access memory (ReRAM) and a dynamic random-access memory (DRAM).

Some embodiments of the present disclosure further provide a chip. The chip includes a programmable logic circuit and/or a program instruction. wherein the chip, when running, is configured to perform the identifier allocation method or the identifier reporting method mentioned above.

Some embodiments of the present disclosure further provide a computer program product or a computer program. The computer program product or the computer program includes a computer instruction stored in a computer-readable storage medium, wherein the computer instructions, when read from the computer-readable storage medium and executed by a processor, cause the processor to perform the identifier allocation method or the identifier reporting method mentioned above.

It should be understood that, the term “indication” mentioned in the embodiments of the present disclosure may be a direct indication, an indirect indication, or an indication of an association relationship. For example, the expression A indicates B may represent that A directly indicates B, for example, B may be acquired by A; or indirectly indicates B, for example, A indicates C, and B may be acquired by C; or may represent that A and B have an association relationship.

In the description of the embodiments of the present disclosure, the term “corresponding” may represent that two objects have a direct or indirect corresponding relationship, or represent that two objects have an association relationship, or represent that a relationship of indicating and being indicated, configuring and being configure, or the like.

The expression “a plurality of” mentioned herein refers to two or more. The term “and/or” describes an association relationship for describing associated objects, and indicates that three types of relationships may exist. For example, A and/or B may represent the following three cases: only A exists, both A and B exist, and only B exists. The symbol “/” generally indicates an “or” relationship between the associated objects.

In addition, serial numbers of the steps described herein merely show a possible execution sequence of the steps. In some other embodiments, the above steps may also be executed out of the number sequence. For example, two steps with different serial numbers may be executed at the same time or two steps with different serial numbers may be executed according to a sequence opposite to that shown in the figure, which is not limited in the embodiments of the present disclosure.

A person skilled in the art shall appreciate that in one or more examples described above, the functions described in the embodiments of the present disclosure may be implemented by hardware, software, firmware, or any combination thereof. If the functions are implemented by the software, they may be stored in a computer-readable medium or transmitted as one or more instructions or codes on a computer-readable medium. The computer-readable medium includes a computer storage medium and a communication medium, wherein the communication medium includes any medium that facilitates transfer of a computer program from one place to another, and the storage medium may be any available medium that can be accessed by a general-purpose or special-purpose computer.

Described above are only exemplary embodiments of the present disclosure, and are not intended to limit the present disclosure. Any modifications, equivalent substitutions, improvements, and the like, made within the spirit and principles of the present disclosure should fall within the protection scope of the present disclosure.

1. A node device, wherein the node device is a device for connecting an access and mobility management function (AMF) to a terminal device, and the node device comprises a transceiver; wherein the transceiver is configured to:
receive a plurality of temporary identifiers allocated in bulk by the AMF; and
separately allocate one of the plurality of temporary identifiers to the terminal device.

2. The node device according to claim 1, wherein the transceiver is configured to:
transmit a request message to the AMF, wherein the request message is configured to request the AMF to allocate the temporary identifiers in bulk; and
receive a response message from the AMF, wherein the response message carries the plurality of temporary identifiers.

3. The node device according to claim 2, wherein the node device comprises any one of a local AMF, a radio access network (RAN), or a relay terminal; wherein
in a case that the node device is the local AMF, the request message and the response message are messages transmitted over a non-access stratum (NAS) message; or
in a case that the node device is the local AMF, the request message and the response message are messages transmitted over a wired connection between the local AMF and the AMF; or
in a case that the node device is the RAN, the request message and the response message are messages transmitted over the NAS message; or
in a case that the node device is the RAN, the request message and the response message are messages transmitted over an access stratum (AS) message; or
in a case that the node device is the RAN, the request message and the response message are messages transmitted over a wired connection between N2 interfaces between the RAN and the AMF; or
in a case that the node device is the relay terminal, the request message and the response message are messages transmitted over the NAS message; or
in a case that the node device is the relay terminal, the request message and the response message are messages transmitted over the AS message.

4. The node device according to claim 1, wherein
the transceiver is configured to transmit a report message to the AMF, wherein the report message carries a plurality of temporary identifiers, and each of the plurality of temporary identifiers has been configured for a corresponding terminal device.

5. The node device according to claim 4, wherein
the transceiver is configured to transmit the report message to the AMF upon completion of a first negotiation process between the node device and a plurality of terminal devices, wherein the first negotiation process is configured for the node device to separately allocate the temporary identifier to the terminal device, and the temporary identifier is one of a plurality of temporary identifiers allocated in bulk by the AMF to the node device.

6. The node device according to claim 5, wherein the node device comprises any one of a local AMF, a radio access network (RAN), or a relay terminal;
in a case that the node device is the local AMF, the first negotiation process is a registration process initiated by the terminal device to the local AMF over a non-access stratum (NAS) message; or
in a case that the node device is the RAN, the first negotiation process is a registration process initiated by the terminal device to the RAN over the NAS message; or
in a case that the node device is the RAN, the first negotiation process is a radio resource control (RRC) connection establishment process initiated by the terminal device to the RAN over an access stratum (AS) message; or
in a case that the node device is the relay terminal, the first negotiation process is a connection establishment process initiated by the terminal device to the relay terminal over a PC5 connection.

7. The node device according to claim 4, wherein
the transceiver is configured to transmit the report message to the AMF upon completion of a second negotiation process between the node device and a plurality of terminal devices, wherein the second negotiation process is configured for the node device to acquire the temporary identifiers of the terminal devices which are configured in advance.

8. The node device according to claim 7, wherein the node device comprises any one of a local AMF, a radio access network (RAN), or a relay terminal; wherein
in a case that the node device is the local AMF, the second negotiation process is a registration process initiated by the terminal device to the local AMF over a non-access stratum (NAS) message; or
in a case that the node device is the RAN, the second negotiation process is a registration process initiated by the terminal device to the RAN over the NAS message; or
in a case that the node device is the RAN, the second negotiation process is an RRC connection establishment process initiated by the terminal device to the RAN over an access stratum (AS) message; or
in a case that the node device is the relay terminal, the second negotiation process is a connection establishment process initiated by the terminal device to the relay terminal over a PC5 connection.

9. An access and mobility management function (AMF), comprising a transceiver; wherein
the transceiver is configured to transmit a plurality of temporary identifiers allocated in bulk by the AMF to a node device, such that the node device separately allocates one of the plurality of temporary identifiers to a terminal device, wherein the node device is a device for connecting the AMF to the terminal device.

10. The AMF according to claim 9, wherein the transceiver is configured to:
receive a request message from the node device, wherein the request message is configured to request the AMF to allocate the temporary identifiers in bulk; and
transmit a response message to the node device, wherein the response message carries the plurality of temporary identifiers.

11. The AMF according to claim 10, wherein the node device comprises any one of a local AMF, a radio access network (RAN), or a relay terminal; wherein
in a case that the node device is the local AMF, the request message and the response message are messages transmitted over a non-access stratum (NAS) message; or
in a case that the node device is the local AMF, the request message and the response message are messages transmitted over a wired connection between the local AMF and the AMF; or
in a case that the node device is the RAN, the request message and the response message are messages transmitted over the NAS message; or
in a case that the node device is the RAN, the request message and the response message are messages transmitted over an access stratum (AS) message; or
in a case that the node device is the RAN, the request message and the response message are messages transmitted over a wired connection between N2 interfaces between the RAN and the AMF; or
in a case that the node device is the relay terminal, the request message and the response message are messages transmitted over the NAS message; or
in a case that the node device is the relay terminal, the request message and the response message are messages transmitted over the AS message.

12. The AMF according to claim 10, further comprising a processor; wherein the processor is configured to:
determine a number of temporary identifiers in the response message based on an identifier request number carried in the request message, wherein the identifier request number is the number of temporary identifiers requested by the node device; or
determine the number of temporary identifiers in the response message based on identity identification information of the node device.

13. The AMF according to claim 9, wherein
the transceiver is configured to receive a report message from the node device, wherein the report message carries a plurality of temporary identifiers, each of the plurality of temporary identifiers has been configured for a corresponding terminal device.

14. The AMF according to claim 13, wherein the node device comprises any one of a local AMF, a radio access network (RAN), or a relay terminal; wherein
in a case that the node device is the local AMF, the report message is a message transmitted over a non-access stratum (NAS) message; or
in a case that the node device is the local AMF, the report message is a message transmitted over a wired connection between the local AMF and the AMF; or
in a case that the node device is the RAN, the report message is a message transmitted over the NAS message; or
in a case that the node device is the RAN, the report message is a message transmitted over an access stratum (AS) message; or
in a case that the node device is the RAN, the report message is a message transmitted over a wired connection between N2 interfaces between the RAN and the AMF; or
in a case that the node device is the relay terminal, the report message is a message transmitted over the NAS message; or
in a case that the node device is the relay terminal, the report message is a message transmitted over the AS message.

15. A terminal device, comprising a transceiver; wherein
the transceiver is configured to receive a temporary identifier separately allocated by a node device, wherein the node device is a device for connecting an access and mobility management function (AMF) to the terminal device, and the temporary identifier is one of a plurality of temporary identifiers allocated in bulk by the AMF to the node device.

16. The terminal device according to claim 15, wherein
the transceiver is configured to receive the temporary identifier separately allocated by the node device by a first negotiation process between the terminal device and the node device.

17. The terminal device according to claim 16, wherein the node device comprises any one of a local AMF, a radio access network (RAN), or a relay terminal; wherein
in a case that the node device is the local AMF, the first negotiation process is a registration process initiated by the terminal device to the local AMF over a non-access stratum (NAS) message; or
in a case that the node device is the RAN, the first negotiation process is a registration process initiated by the terminal device to the RAN over the NAS message; or
in a case that the node device is the RAN, the first negotiation process is an RRC connection establishment process initiated by the terminal device to the RAN over an access stratum (AS) message; or
in a case that the node device is the relay terminal, the first negotiation process is a connection establishment process initiated by the terminal device to the relay terminal over a PC5 connection.

18. The terminal device according to claim 15, wherein
the transceiver is configured to enable the node device to acknowledge a temporary identifier that has been configured for the terminal device by a negotiation process between the terminal device and the node device.

19. The terminal device according to claim 18, wherein
the negotiation process comprises a first negotiation process, wherein the first negotiation process is configured for the node device to separately allocate the temporary identifier to the terminal device, and the temporary identifier is one of a plurality of temporary identifiers allocated in bulk by the AMF to the node device.

20. The terminal device according to claim 18, wherein
the negotiation process comprises a second negotiation process, wherein the second negotiation process is configured for the node device to acquire the temporary identifier of the terminal device which is configured in advance.
